(19) United States
(12) Patent Application Publication
(10) Pub. No.: US 2020/0357108 A1
(43) Pub. Date: Nov. 12, 2020

(54) TARGET DETECTION METHOD AND APPARATUS, AND MOVABLE PLATFORM

(71) Applicant: SZ DJI TECHNOLOGY CO., LTD., Shenzhen (CN)

(72) Inventors: You ZHOU, Shenzhen (CN); Jiaqi YAN, Shenzhen (CN); Zhiyuan WU, Shenzhen (CN)

(21) Appl. No.: 16/937,084

(22) Filed: Jul. 23, 2020

Related U.S. Application Data
(63) Continuation of application No. PCT/CN2018/073890, filed on Jan. 23, 2018.

(51) Int. Cl. G06T 7/00; G06T 7/70; G06T 7/20

(52) U.S. Cl. CPC G06T 7/0002; G06T 7/70; G06T 2207/20132; G06T 2207/10028; G06T 7/20

(57) ABSTRACT

A target detection method includes obtaining a depth image, performing detection on the depth image based on a detection algorithm, and, in response to obtaining a candidate region of a target object as a result of the detection, determining whether the candidate region of the target object is an effective region of the target object based on a verification algorithm.

### CROSS-REFERENCE TO RELATED APPLICATION

This application is a continuation of International Application No. PCT/CN2018/073890, filed on Jan. 23, 2018, the entire content of which is incorporated herein by reference.

### TECHNICAL FIELD

The present disclosure relates to the technical field of movable platform technology and, more particularly, to a target detection method and apparatus, and a movable platform.

### BACKGROUND

With the development of technology and cost reduction, more and more users begin to use unmanned aerial vehicles (UAV) for aerial photographing. It becomes more convenient and more flexible to control the UAVs. For example, the UAVs can be controlled by a remote control joystick, or may be controlled by gestures and body postures.

At present, it is difficult to recognize control gestures and accurately identify hands and bodies. Two methods are observation based on two-dimensional (2D) images and detection based on three-dimensional (3D) depth images. Detection based on 3D depth images results in an accurate 3D position.

However, the quality of the 3D depth images is often not good. Computing resource of UAV-mounted platforms is often limited. It is difficult to obtain high quality 3D depth images. Thus, target detection is inaccurate, and errors may occur.

### SUMMARY

In accordance with the disclosure, there is provided a target detection method including obtaining a depth image, performing detection on the depth image based on a detection algorithm, and, in response to obtaining a candidate region of a target object as a result of the detection, determining whether the candidate region of the target object is an effective region of the target object based on a verification algorithm.

Also in accordance with the disclosure, there is provided a target detection method including obtaining a depth image, performing detection on the depth image based on a detection algorithm, and, in response to obtaining a candidate region of a target object as a result of the detection, obtaining an alternative region of the target object in a current grayscale image of a current time based on a target tracking algorithm using the candidate region of the target object as a reference region of the target object at the current time in the target tracking algorithm.

Also in accordance with the disclosure, there is provided a target detection method including performing detection on a primary image obtained by a primary camera, and, in response to obtaining a candidate region of a target object as a result of the detection, obtaining an alternative region of the target object in a current grayscale image of a current time based on a target tracking algorithm using the candidate region of the target object as a reference region of the target object at the current time in the target tracking algorithm.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an unmanned aerial vehicle system according to an embodiment of the present disclosure.

FIG. 2 is a flowchart of a target detection method according to an example embodiment of the present disclosure.

FIG. 3 is a schematic diagram of an algorithm related to the method shown in FIG. 2.

FIG. 4 is a flowchart of a target detection method according to another example embodiment of the present disclosure.

FIG. 5 is a flowchart of a target detection method according to another example embodiment of the present disclosure.

FIG. 6 is a schematic diagram of an algorithm related to the method shown in FIG. 5.

FIG. 7 is a flowchart of a target detection method according to another example embodiment of the present disclosure.

FIG. 8 is a schematic diagram of an algorithm related to the method shown in FIG. 7.

FIG. 9 is a schematic diagram showing cropping images based on an image aspect ratio according to the example embodiment shown in FIG. 7.

FIG. 10 is a schematic diagram showing scaling images based on a focal length according to the example embodiment shown in FIG. 7.

FIG. 11 is a schematic diagram showing obtaining a projection candidate region corresponding to a reference candidate region according to the example embodiment shown in FIG. 7.

FIG. 12 is a flowchart of a target detection method according to another example embodiment of the present disclosure.

FIG. 13 is a schematic diagram of an algorithm related to the method shown in FIG. 12.

FIG. 14 is a flowchart of a target detection method according to another example embodiment of the present disclosure.

FIG. 15 is a schematic diagram of an algorithm related to the method shown in FIG. 14.

FIG. 16 is a flowchart of an implementation of the target detection method according to the example embodiment shown in FIG. 14.

FIG. 17 is a flowchart of another implementation of the target detection method according to the example embodiment shown in FIG. 14.

FIG. 18 is a flowchart of another implementation of the target detection method according to the example embodiment shown in FIG. 14.

FIG. 19 is a flowchart of a target detection method according to another example embodiment of the present disclosure.

FIG. 20 is a flowchart of an implementation of the target detection method according to the example embodiment shown in FIG. 19.

FIG. 21 is a flowchart of another implementation of the target detection method according to the example embodiment shown in FIG. 19.

FIG. 22 is a flowchart of another implementation of the target detection method according to the example embodiment shown in FIG. 19.

FIG. 23 is a schematic structural diagram of a target detection apparatus according to an embodiment of the present disclosure.

FIG. 24 is a schematic structural diagram of a target detection apparatus according to another embodiment of the present disclosure.

FIG. 25 is a schematic structural diagram of a target detection apparatus according to an embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

The present disclosure provides a target detection method, a target detection apparatus, and a movable platform. The movable platform includes, but is not limited to, an unmanned aerial vehicle (UAV) and an unmanned automobile. In various embodiments of the present disclosure, the UAV is illustrated. The UAV can be a rotorcraft, for example, a multi-rotor aircraft propelled by multiple air propulsion devices, but the embodiments of the present disclosure are not limited thereto.

FIG. 1 is a schematic structural diagram of an unmanned aerial vehicle (UAV) system 100 according to an embodiment of the present disclosure. For illustrative purposes, the UAV is a rotor UAV.

The UAV system 100 includes a UAV 110 and a gimbal 120. The UAV 110 includes a power system 150, a flight control system 160, and a frame. In some embodiments, the UAV system 100 also includes a display device 130. The UAV 110 wirelessly communicates with the display device 130.

The frame includes a body and a stand (also called landing gear). The body includes a center frame and one or more arms connected to the center frame. The one or more arms extend radially from the center frame. The stand is connected to the body for supporting the UAV 100 when the UAV 110 lands.

The power system 150 includes one or more electronic speed controllers (ESC) 151, one or more propellers 153, and one or more electric motors 152 corresponding to the one of more propellers 153. The one or more electric motors 152 connect between the one or more ESCs 151 and the one or more propellers 153. The one or more electric motors 152 and the one or more propellers 153 are disposed at the one or more arms of the UAV 110. The one or more ESCs 151 are configured to receive driving signals generated by the flight control system 160, and to supply driving currents to the one or more electric motors 152 to control rotation speeds of the one or more electric motors 152 based on the driving signals. The one or more electric motors 152 are configured to drive the one or more propellers 153 to rotate, thereby supplying flying power to the UAV 110. The flying power drives the UAV 110 to move at one or more degrees of freedom. In some embodiments, the UAV 110 rotates around one or more rotation axes. For example, the one or more rotation axes include a roll axis, a yaw axis, and a pitch axis. In some embodiments, the one or more electric motors 152 may be direct current (DC) electric motors or alternate current (AC) electric motors. In addition, the one or more electric motors 152 may be brushless electric motors or brush electric motors.

The flight control system 160 includes a flight controller 161 and a sensor system 162. The sensor system 162 is configured to measure position-attitude information of the UAV 110, that is, spatial position information and status information of the UAV 110, such as a three-dimensional (3D) position, a 3D angle, a 3D speed, a 3D acceleration, and a 3D angular velocity. The sensor system 162 includes at least one of a gyroscope, an ultrasonic sensor, an electronic compass, an inertial measurement unit (IMU), a visual sensor, a global navigation satellite system, or a barometer. For example, the global navigation satellite system is the global positioning system (GPS). The flight controller 161 is configured to control the flight of the UAV 110. For example, the flight controller 161 controls the flight of the UAV 110 based on the position-attitude information measured by the sensor system 162. In some embodiments, the flight controller 161 may control the flight of the UAV 110 according to pre-programmed program instructions or may control the flight of the UAV 110 through photographed images.

The gimbal 120 includes an electric motor 122. The gimbal is configured to carry a photographing device 123. The flight controller 161 controls movement of the gimbal 120 through the electric motor 122. In some embodiments, the gimbal 120 also includes a controller configured to control the movement of the gimbal 120 through the electric motor 122. In some embodiments, the gimbal may operate independent of the UAV 110 or may be part of the UAV 110. In addition, the electric motor 122 may be a brushless electric motor or a brush electric motor. The gimbal may be located at a top of the UAV 110 or at a bottom of the UAV 110.

The photographing device 123 may be an image photographing device, such as a camera or a camcorder. The photographing device 123 may communicate with the flight controller 161 and may photograph images under the control of the flight controller 161. The flight controller 161 may control the UAV 110 based on the images photographed by the photographing device 123. In some embodiments, the photographing device 123 includes to least a photosensitive component. The photosensitive component may be a complementary metal oxide semiconductor (CMOS) sensor or a charge-coupled device (CCD) sensor. The photographing device 123 may be directly mounted at the UAV 110 by omitting the gimbal 120.

The display device 130 is located at a ground terminal of the UAV system, wirelessly communicates with the UAV 110, and displays the position-attitude information of the UAV 110. In addition, the display device 130 also displays the images photographed by the photographing device 123. In some embodiments, the display device 130 is a device independent of the UAV 110.

It should be understood that the above naming of the parts of the UAV system is for identification purposes only, and should not be construed as limiting the embodiments of the present disclosure.

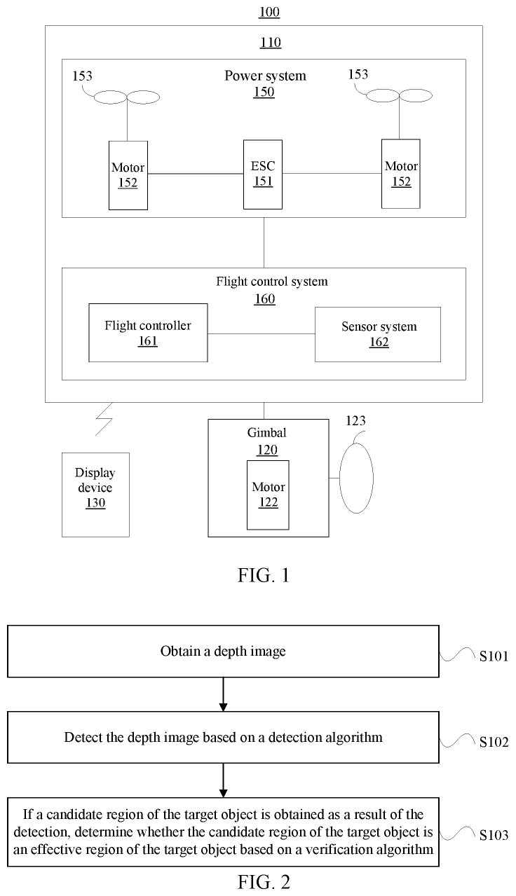

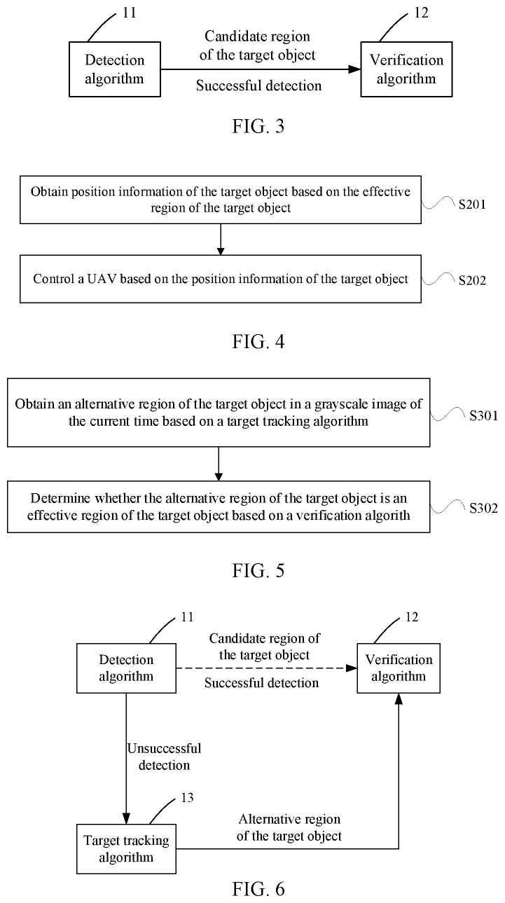

FIG. 2 is a flowchart of a target detection method according to an example embodiment of the present disclosure. FIG. 3 is a schematic diagram of an algorithm related to the method shown in FIG. 2. The target detection method can be performed by, e.g., a target detection apparatus. The target detection apparatus may be disposed at a UAV. As shown in FIG. 2, the target detection method includes: obtaining a depth image (S101); and detecting the depth image according to a detection algorithm (S102).

In some embodiments, the UAV detects an image photographed by an image collector to obtain a target object, and then controls the UAV. For example, in a mode that the UAV is controlled by a hand gesture or a body posture, the image is detected. The depth image or depth map, also known as a range image or a range map, refers to an image having each pixel value to be a distance (also known as a depth or a depth of field) between the image collector and a corresponding point in a scene. The depth image expresses the 3D scene information, directly reflects geometric shapes of visible surfaces of the scene. In some embodiments, the type of the image collector on the UAV may be different, and the way to obtain the depth image may be different.

In some embodiments, obtaining the depth image includes obtaining a grayscale image through a sensor; and obtaining the depth image based on the grayscale image. For example, the grayscale image is first obtained by the sensor, and then the depth image is generated based on the grayscale image. It is suitable for the scene that the depth image cannot be obtained directly. For example, the sensor is a binocular vision system, or monocular vision system, or a primary camera. Based on a plurality of images of a same scene, the monocular vision system or the primary camera calculates a depth of each pixel to generate the depth image. The present disclosure does not limit implementation methods of obtaining the depth image based on the grayscale image.

In some embodiments, the sensor may directly obtain the depth image, and the method is suitable for the scene that the depth image can be directly obtained. For example, the sensor is a time of flight (TOF) sensor. The TOF sensor may obtain both the depth image and the grayscale image at the same time or may obtain either depth image or the grayscale image individually.

In some embodiments, obtaining the depth image includes: obtaining an image by the primary camera and obtaining an original depth image by the sensor corresponding to the image obtained by the primary camera; detecting the image according to a detection algorithm to obtain a reference candidate region of a target object; and based on the reference candidate region and the original depth image, obtaining the depth image corresponding to the reference candidate region on the original depth image.

In one example, the obtained depth image is required to be detected to recognize the target object. The target object occupies only a small region in the depth image. If the entire depth image is detected, the amount of calculation is substantial and substantial computing resource is used. The image obtained by the primary camera often has a higher resolution. Performing the detection algorithm on the image obtained by the primary camera often produces a more accurate detection result. The detection result is the reference candidate region including the target object. On the original depth image matching the image obtained by the primary camera, a small region corresponding to the reference candidate region of the target object is cropped out as the depth image to be detected. Then, performing the detection on the small region of the depth image to recognize the target object reduces the amount of calculation, occupies less computing resource, and improves a resource utilization rate and a target detection speed. The present disclosure does not limit the image obtained by the primary camera. The image obtained by the primary camera may be a color RGB image, or may be a depth image generated from a plurality of RGB images.

The present disclosure does not limit the implementation of the detection algorithm. The degree of coupling between two adjacent detections of the detection algorithm often is low and the accuracy of detection is high. The detection algorithm for the depth image and the image obtained by the primary camera may be the same or may be different.

At S103, if the detection obtains the candidate region for the target object, a verification algorithm is used to determine whether the candidate region is an effective region for the target object.

Referring to FIG. 3, the target detection method involves a detection algorithm 11 and a verification algorithm 12. The depth image is detected based on the detection algorithm to obtain one of two detection results. If the detection is successful, the candidate region of the target object is obtained. If the detection is unsuccessful, no target object is recognized. Even if the detection is successful and the candidate region of the target object is obtained, the detection result is not necessarily accurate, especially for the target object with a small size and a complicated shape. Thus, in some embodiments, the candidate region of the target object is further verified by the verification algorithm to determine whether the candidate region of the target object is effective. If the candidate region of the target object is effective, the candidate region of the target object becomes an effective region of the target object.

In the target detection method provided by the present disclosure, after the depth image is detected by the detection algorithm to obtain the candidate region of the target object, the detection result of the detection algorithm is further verified by the verification algorithm to determine whether the candidate region of the target object is effective, thereby improving the accuracy of the target detection.

The present disclosure does not limit the implementation of the verification algorithm, which can be configured as needed. In some embodiments, the verification algorithm may be a convolutional neural network (CNN) algorithm. In some other embodiments, the verification algorithm may be a template matching algorithm.

In some embodiments, the verification algorithm may provide a probability that each candidate region of the target object may include the target object. For example, a hand is recognized with various probabilities corresponding to various candidate regions. The probability of a first candidate region including the hand is 80% and the probability of a second candidate region including the hand is 50%. Then, the candidate region that has at least 60% probability of including the hand is determined to be the effective region including the hand.

In some embodiments, the candidate region of the target object can be the region in the depth image including the target object. In some embodiments, the candidate region of the target object includes 3D scene information. In some embodiments, the candidate regions of the target object can be the region in the grayscale image. The grayscale image corresponds to the depth image. The region in the grayscale image corresponds to the region determined by the detection algorithm to include the target object. In some embodiments, the candidate region of the target object includes 2D scene information. It should be noted that the verification algorithm is related to the type of the candidate region of the target object. For different type of the candidate region of the target object, the type of the verification algorithm, the amount of data calculation, or the algorithm complexity may be different.

In some embodiments, the target object may be any one of the head, the upper arm, the torso, and the hand of a person.

The present disclosure does not limit the number of the target objects. If the target object is more than one, the processes S101-S103 are executed for each target object. For example, the target object includes the head and the hand of the person. The processes S101-S103 are executed for the head of the person and the processes S101-S103 are executed again for the hand of the person.

The present disclosure does not limit the number of the candidate regions of the target object or the number of the effective regions of the target object. The suitable number of the candidate regions of the target object or the suitable number of the effective regions of the target object may be configured based on the type of the target object. For example, if the target object is the head of the person, the number of the candidate regions of the target object is one, and the number of the effective regions of the target object is one. If the target object is the hand of the person, the number of the candidate regions of the target object can be more than one, and the number of the effective regions of the target object is two. In some embodiments, the target object may include more than one person or more than one hand.

The present disclosure provides the target detection method. The method includes: obtaining the depth image; detecting the depth image based on the detection algorithm; and if the candidate region of the target object is obtained in the detection process, determining whether the candidate region is the effective region of the target object based on the verification algorithm. The target detection method provided by the embodiments of the present disclosure detects the depth image based on the detection algorithm and further verifies the detection result based on the verification algorithm to determine whether the detection result of the detection algorithm is accurate, thereby improving the accuracy of the target detection.

FIG. 4 is a flowchart of a target detection method according to another example embodiment of the present disclosure. The present disclosure provides another example implementation of the target detection method when the candidate region of the target object obtained by using the detection algorithm to detect the depth image is the effective region. As shown in FIG. 4, after the process at S103, the target detection method further includes, if the candidate region of the target object is determined to be the effective region of the target object by the verification algorithm, obtaining position information of the target object based on the effective region of the target object (S201), and controlling the UAV based on the position information of the target object (S202).

In one example, the position information of the target object is the position information in a 3D coordinate system, and can be represented by a 3D coordinate (x, y, z). In some embodiments, the 3D coordinate is with reference to the camera. In some other embodiments, the 3D coordinate is with reference to the ground. In the geodetic coordinate system, the positive direction of the x-axis is north, the positive direction of the y-axis is east, and the positive direction of the z-axis is pointing to the center of the Earth. After the position information of the target object is obtained, the UAV is controlled based on the position information of the target object. For example, the flight altitude, the flight direction, and the flight mode (flying in a straight line or in a circle) of the UAV may be controlled.

Controlling the UAV based on the position information of the target object reduces the complexity of controlling the UAV and improves the user experience.

In some embodiments, if the effective region of the target object is the region in the depth image including the target object, the position information of the target object can be directly obtained based on the effective region of the target object at S201.

In some embodiments, if the effective region of the target object is a region in the grayscale image corresponding to the depth image and including the target object, obtaining the position information of the target object based on the effective region of the target object (S201) includes: determining a region in the depth image corresponding to the effective region of the target object based on the effective region of the target object; and obtaining the position information of the target object based on the region in the depth image corresponding to the effective region of the target object.

In some embodiments, if the target object itself carries the position information, the position information of the target object can be directly determined.

In some embodiments, if the position information of the target object is the position information in a camera coordinate system, the detection method further includes, before controlling the UAV based on the position information of the target object (S202),converting the position information of the target object to be in the geodetic coordinate system.

In one example, after the position information in the camera coordinate system is converted to the position information in the geodetic coordinate system, the rotation of the UAV may be eliminated, and the flight control of the UAV is less complicated.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

In one example, after the position information of the target object in the camera coordinate system is obtained, the position information in the camera coordinate system can be combined with current position-attitude information of the UAV (obtained by IMU+VO+GPS) to obtain the position-attitude information in the geodetic coordinate system (also referred to as “ground coordinate system”).

The target detection method provided by the present disclosure determines the position information of the target object through the effective region of the target object, controls the UAV based on the position information of the target object, thereby reducing the complexity of controlling the UAV, and improving the user experience.

FIG. 5 is a flowchart of a target detection method according to another example embodiment of the present disclosure. FIG. 6 is a schematic diagram of an algorithm related to the method shown in FIG. 5. The present disclosure provides another example implementation of the target detection method when the detection algorithm fails to detect the candidate region of the target object in the depth image. As shown in FIG. 5 and FIG. 6, after the process at S102, the target detection method further includes, if the candidate region of the target object is not obtained, obtaining an alternative region of the target object in the grayscale image of the current time (also referred to as a “grayscale image corresponding to the current time” or a “current grayscale image”) based on a target tracking algorithm (S301).

Referring to FIG. 6, the target detection method involves the detection algorithm 11, the verification algorithm 12, and a target tracking algorithm 13. If the detection on the depth image based on the detection algorithm fails, tracking of the target object may be performed on the grayscale image of the current time based on the target tracking algorithm to obtain the alternative region of the target object. In the embodiments of the present disclosure, for differentiation, the candidate region of the target object is obtained through the detection algorithm, and the alternative region of the target region is obtained through the target tracking algorithm.

In some embodiments, the target tracking algorithm establishes position relationship of an object in a consecutive video sequence to obtain a complete movement trajectory of the object. In other words, if a target coordinate position in a first image frame is given, the exact position of the target in a succeeding image frame can be calculated based on the target coordinate position in the first image frame. The present disclosure does not limit how to implement the target tracking algorithm.

At S302, whether the alternative region of the target object is the effective region of the target object is determined based on the verification algorithm.

In one example, the alternative region of the target object is obtained based on the target tracking algorithm. The result may not be accurate. Moreover, the accuracy of the target tracking algorithm depends on the position information of the target object treated as a target tracking reference. When the target tracking reference deviates, the accuracy of the target tracking algorithm is severely affected. Thus, in some embodiments, the alternative region of the target object is further verified based on the verification algorithm to determine whether the alternative region of the target object is valid. When the alternative region of the target object is valid, the alternative region of the target object is considered as the effective region of the target object.

In some embodiments, when the detection on the depth image based on the detection algorithm fails, the grayscale image of the current time is processed based on the target tracking algorithm to obtain the alternative region of the target object, and the result of the target tracking algorithm is further verified based on the verification algorithm to determine whether the alternative region of the target object is valid, thereby improving the accuracy of the target detection.

In some embodiments, obtaining the alternative region of the target object in the grayscale image of the current time (S301) includes: obtaining the alternative region of the target object based on the grayscale image of the current time and the effective region of the reference target object. The effective region of the reference target object includes any one of the following: the effective region of the target object last determined based on the verification algorithm, the candidate region of the target object last determined by detecting the depth image based on the detection algorithm, and the alternative region of the target object last determined based on the target tracking algorithm. In some embodiments, the last determination may refer to the determination of the corresponding region in the image immediately preceding the current image in the image sequence, or in a plurality of images preceding the current image in the image sequence, which is not limited by the present disclosure.

In one example, because the degree of coupling between two adjacent results of the target tracking algorithm is high, and the tracking is a recursive process, errors may accumulate and the accuracy may become lower and lower over time. Thus, the reference in the target tracking algorithm needs to be corrected to improve the accuracy of the target tracking algorithm. The effective region of the reference target object includes any one of the following: the effective region of the target object last determined based on the verification algorithm, and the candidate region of the target object last determined by detecting the depth image based on the detection algorithm. At the current time, if the above two types of the information cannot be obtained, the effective region of the reference target object is the alternative region of the target object last determined based on the target tracking algorithm.

In some embodiments, if the effective region of the reference target object is the candidate region of the target object last determined by detecting the depth image based on the detection algorithm, the target object may be the head, the upper arm, or the torso of the person.

In one example, when the size of the target object is large and the shape of the target object is simple, the result obtained by detecting the depth image based on the detection algorithm is more accurate. Thus, the effective region of the target object last determined based on the verification algorithm becomes the effective region of the reference target object for the target tracking algorithm at the current time, thereby further improving the accuracy of the target tracking algorithm.

The present disclosure does not limit the time relationship between the grayscale image of the current time and the depth image at 8101.

In some embodiments, a first frequency is greater than a second frequency. The first frequency is the frequency of obtaining the alternative region of the target object in the grayscale image of the current time based on the target tracking algorithm. The second frequency is the frequency of detecting the depth image based on the detection algorithm.

In some embodiments, the depth image obtained at S101 is the depth image before the grayscale image of the current time is obtained. Because detecting the depth image based on the detection algorithm consumes a substantial amount of computing resources, it is suitable for mobile device such as the UAV where the computing resources are limited. For example, at the current time, the candidate region of the target object in the depth image is obtained, and the alternative region of the target object in the grayscale image is obtained. Because the frequencies of obtaining both are different, at the succeeding times, only the alternative region of the target object in the grayscale image is obtained, or only the candidate region of the target object in the depth image is obtained. In some embodiments, when the candidate region of the target object in the depth image is obtained, the process of obtaining the alternative region of the target object in the grayscale image can be turned off to reduce resource consumption.

In some embodiments, the first frequency is equal to the second frequency. In some embodiments, the depth image obtained at S101 is the depth image obtained at the current time and corresponds to the grayscale image also obtained at the current time. Because the first frequency is equal to the second frequency, the accuracy of the target detection is further improved.

In some embodiments, after S302, the target detection method provided by the present disclosure further includes: if the alternative region of the target object is the effective region of the target object, the position information of the target object is obtained based on the effective region of the target object.

In some embodiments, after the position information of the target object is obtained based on the effective region of the target object, the target detection method provided by the present disclosure further includes: controlling the UAV based on the position information of the target object.

In some embodiments, if the position information of the target object is the position information in the camera coordinate system, the target detection method provided by the present disclosure further includes, before controlling the UAV based on the position information of the target object, converting the position information of the target object to the position information in the geodetic coordinate system.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

Because the operation principle is similar to the example embodiment shown in FIG. 4, the detailed description is omitted.

The present disclosure does not limit the number of the alternative regions of the target object or the number of the effective regions of the target object. The suitable number of the alternative regions of the target object or the suitable number of the effective regions of the target object may be configured based on the type of the target object. For example, if the target object is the head of the person, the number of the alternative regions of the target object is one, and the number of the effective regions of the target object is one. If the target object is both hands of the person, the number of the candidate regions of the target object is two, and the number of the effective regions of the target object is two. In some embodiments, the target object may include multiple persons or multiple hands of the multiple persons.

The present disclosure provides the target detection method. The method includes: when detecting the depth image based on the detection algorithm fails, obtaining the alternative region of the target object in the grayscale image of the current time based on the target tracking algorithm; and determining whether the alternative region of the target object is the effective region of the target object based on the verification algorithm. The target detection method provided by the embodiments of the present disclosure processes the grayscale image of the current time based on the target tracking algorithm; and verifying the result of the target tracking algorithm based on the verification algorithm to determine whether the result of the target tracking algorithm is accurate, thereby improving the accuracy of the target detection.

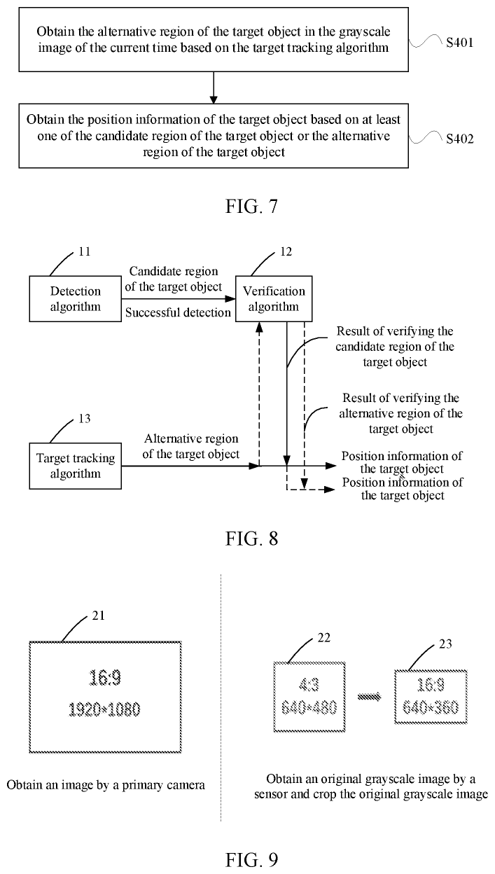

FIG. 7 is a flowchart of a target detection method according to another example embodiment of the present disclosure. FIG. 8 is a schematic diagram of an algorithm related to the method shown in FIG. 7. The present disclosure provides another example embodiment of the target detection method. When both the detection algorithm and the target tracking algorithm are performed, the target detection method provides additional process for determining the position information of the target object. As shown in FIG. 7 and FIG. 8, the target detection method further includes: obtaining the alternative region of the target object in the grayscale image of the current time based on the target tracking algorithm (S401) and obtaining the position information of the target object based on at least one of the candidate region of the target object or the alternative region of the target object (S402).

Referring to FIG. 8, the target detection method involves the detection algorithm 11, the verification algorithm 12, and the target tracking algorithm 13. Both the target tracking algorithm and the detection algorithm are performed. The grayscale image of the current time is proceeded based on the target tracking algorithm to obtain a processing result. The processing result includes the alternative region of the target object. The depth image is processed based on the detection algorithm to obtain a detection result. The detection result includes the candidate region of the target object. Moreover, the candidate region of the target object is verified based on the verification algorithm to determine whether the candidate region of the target object is valid.

In the target detection method provided by the present disclosure, based on the results of both the target tracking algorithm and the detection algorithm, the position information of the target object can be determined according to at least one of the candidate region of the target object or the alternative region of the target object, thereby improving the accuracy of the position information of the target object.

In some embodiments, the target detection method further includes, after the position information of the target object is obtained at S402, controlling the UAV based on the position information of the target object.

In some embodiments, if the position information of the target object is the position information in the camera coordinate system, before controlling the UAV based on the position information of the target object, the target detection method further includes: converting the position information of the target object to the position information in the geodetic coordinate system.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

Because the operation principle is similar to the example embodiment shown in FIG. 4, the detailed description is omitted.

In some embodiments, obtaining the position information of the target object based on at least one of the candidate region of the target object or the alternative region of the target object (S402) includes: if the candidate region of the target object is the effective region of the target object, obtaining the position information of the target object based on the effective region of the target object.

In one example, if the candidate region of the target object obtained based on the detection algorithm is the effective region of the target object, and the candidate region if the target object is determined to be valid based on the verification algorithm, the position information of the target object is directly obtained based on the effective region of the target object, thereby improving the accuracy of the position information of the target object.

In some embodiments, obtaining the position information based on at least one of the candidate region of the target object or the alternative region of the target object (S402) includes: if the candidate region of the target object is the effective region of the target object, determining an average value or a weighted average value of first position information and second position information to be the position information of the target object. The average value and the weighted average value are intended to be illustrative, and can include the position information obtained by processing the two pieces of position information. The first position information is the position information of the target object determined based on the effective region of the target object. The second position information is the position information of the target object determined based on the alternative region of the target object.

The present disclosure does not limit the implementation of respective weights corresponding to the first position information and the second position information, which can be configured as needed. In some embodiments, the weight corresponding to the first position information is greater than the weight corresponding to the second position information.

Combining the results of both the detection algorithm and the target tracking algorithm improves the accuracy of the position information of the target object.

In some embodiments, obtaining the position information based on at least one of the candidate region of the target object or the alternative region of the target object (S402) includes: if the candidate region of the target object is not the effective region of the target object, obtaining the position information of the target object based on the alternative region of the target object.

Generally, the validity of the candidate region of the target object determined based on both the detection algorithm and the verification algorithm is often accurate. If the candidate region of the target object is determined not to be the effective region of the target object, the position information of the target object is directly obtained based on the alternative region of the target object

In some embodiments, obtaining the position information based on at least one of the candidate region of the target object or the alternative region of the target object (S402) includes: determining whether the alternative region of the target object is valid based on the verification algorithm. Determining whether the alternative region of the target object is valid based on the verification algorithm further improves the accuracy of the target detection.

Correspondingly, in the three example embodiments of S402, the alternative region of the target object is the alternative region of the target object determined to be valid based on the verification algorithm.

In some embodiments, the first frequency is greater than the second frequency. The first frequency is the frequency of obtaining the alternative region of the target object in the grayscale image of the current time based on the target tracking algorithm. The second frequency is the frequency of detecting the depth image based on the detection algorithm.

Because the operation principle is similar to the example embodiment shown in FIG. 5, the detailed description is omitted.

In some embodiments, obtaining the alternative region of the target object in the grayscale image of the current time based on the target tracking algorithm (S401) includes: obtaining an image of the current time, also referred to as an “image corresponding to the current time” or a “current image,” by the primary camera; obtaining, by the sensor, an original grayscale image matching the image obtained by the primary camera; performing detection on the image obtained by the primary camera to obtain the reference candidate region of the target object; based on the reference candidate region and the original grayscale image, obtaining a projection candidate region corresponding to the reference candidate region; and based on the projection candidate region, obtaining the alternative region of the target object. Hereinafter, an image obtained by the primary camera is also referred to as a “primary image.”

In one example, the image obtained by the primary camera often has a higher resolution. Performing the detection algorithm on the image obtained by the primary camera often produces the more accurate detection result. The detection result is the reference candidate region including the target object. On the original grayscale image matching the image obtained by the primary camera, a small region corresponding to the reference candidate region of the target object is cropped out as the projection candidate region to be detected. Then, the alternative region of the target object obtained by processing the projection candidate region based on the target tracking algorithm is more accurate. At the same time, the method reduces the amount of calculation, and improves the resource utilization rate, and the speed and the accuracy of the target detection. In some embodiments, for differentiation, the reference candidate region of the target object is a region in the image obtained by the primary camera. The projection candidate region is a region in the grayscale image obtained by the sensor.

The present disclosure does not limit the implementation of the detection algorithm for detecting the image obtained by the primary camera.

The present disclosure does not limit the implementation of the target tracking algorithm for obtaining the projection candidate region.

In some embodiments, obtaining the original grayscale image by the sensor matching the image obtained by the primary camera includes: determining the grayscale image having the smallest time stamp difference with the image as the original grayscale image. The grayscale image having the smallest time stamp difference with the image obtained by the primary camera is also referred to as a “closest grayscale image.”

In one example, assuming that the time stamp of the image obtained by the primary camera is TO, and the time stamps of a plurality of grayscale images obtained by the sensor are T1, T2, T3, and T4, respectively. If |T0-T2| is the smallest among |T0-T1|, |T0-T2|, |T0-T3|, and |T0-T4|, the grayscale image corresponding to the time stamp T2 becomes the original grayscale image matching the image. That is, the grayscale image having the smallest time stamp difference with respect to the image obtained by the primary camera is selected. However, in actual applications, the method for selecting the original grayscale image having the smallest difference with the image obtained by the primary camera is not limited to time stamp difference comparison. For example, the images and the grayscale images obtained at close times may be matched and analyzed for differences to obtain the grayscale image closest to the image obtained by the primary camera.

In some embodiments, determining the grayscale image having the smallest time stamp difference with the image to be the original grayscale image includes: obtaining the time stamp of the image and the time stamp of at least one grayscale image within a certain time range of the time stamp of the image; calculating the difference between the time stamp of the image and the time stamp of the at least one grayscale image; and if the smallest of the at least one difference is smaller than a pre-set threshold, determining the grayscale image corresponding to the smallest difference to be the original grayscale image.

The present disclosure does not limit the values of the time range and the pre-set threshold, which can be configured as needed.

For various images in the embodiments of the present disclosure including the grayscale image, the depth image, and the image obtained by the primary camera, each image has a time stamp uniquely identifies the time corresponding thereto. The present disclosure does not limit the format of the time stamp as long as the format of the time stamp is consistent.

In some embodiments, the start-photographing time t1(start of exposure) of an image is used as the time stamp of the image. In some other embodiments, the end-photographing time t2 (end of exposure) is used as the time stamp of the image. In some other embodiments, the mid-photographing time, i.e., t1+(t2−t1)/2, is used as the time stamp of the image.

In some embodiments, after the original grayscale image is obtained by the sensor matching the image obtained by the primary camera, the target detection method further includes: if the image aspect ratio of the image is different from the image aspect ratio of the original grayscale image, the original grayscale image is cropped based on the image aspect ratio of the image.

FIG. 9 is a schematic diagram showing image cropping based on the image aspect ratio according to the example embodiment shown in FIG. 7. Referring to FIG. 9, the left side shows an image 21 obtained by the primary camera, with an image aspect ratio of 16:9 and pixels of 1920*1080. The right side shows an original grayscale image 22 obtained by the sensor, with an image aspect ratio of 4:3 and pixels of 640*360. The original grayscale image 22 is cropped based on the image aspect ratio 16:9 of the image 21 to obtain a cropped original grayscale image 23.

Cropping the original grayscale image based on the image aspect ratio of the image not only saves the image obtained by the primary camera, but also unifies the image aspect ratios of the image and the original grayscale image, thereby improving the accuracy and success rate of the reference candidate region of the target object obtained by detecting the image obtained by the primary camera based on the detection algorithm.

In some embodiments, after the original grayscale image matching the primary image is obtained by the sensor, the target detection method provided by the present disclosure further includes: if the image aspect ratio of the image is different from the image aspect ratio of the original grayscale image, cropping the image based on the image aspect ratio of the original grayscale image.

In some embodiments, cropping the image based on the image aspect ratio of the original grayscale image unifies the image aspect ratios of the image and the original grayscale image.

In some embodiments, after the original grayscale image matching the primary image is obtained by the sensor, the target detection method provided by the present disclosure further includes: if the image aspect ratio of the image is different from the image aspect ratio of the original grayscale image, cropping the image and the original grayscale image based on a pre-set image aspect ratio.

In some embodiments, cropping both the image and the original grayscale image unifies the image aspect ratios of the image and the original grayscale image.

The present disclosure does not limit the value of the pre-set image aspect ratio, which can be configured as needed.

In some embodiments, after the original grayscale image matching the primary image is obtained by the sensor, the target detection method further includes: determining a scaling factor based on the focal length of the image and the focal length of the original grayscale image; and scaling the original grayscale image based on the scaling factor.

In one example, if the image aspect ratio of the image is different from the image aspect ratio of the original grayscale image, cropping the image and the original grayscale image based on the pre-set image aspect ratio.

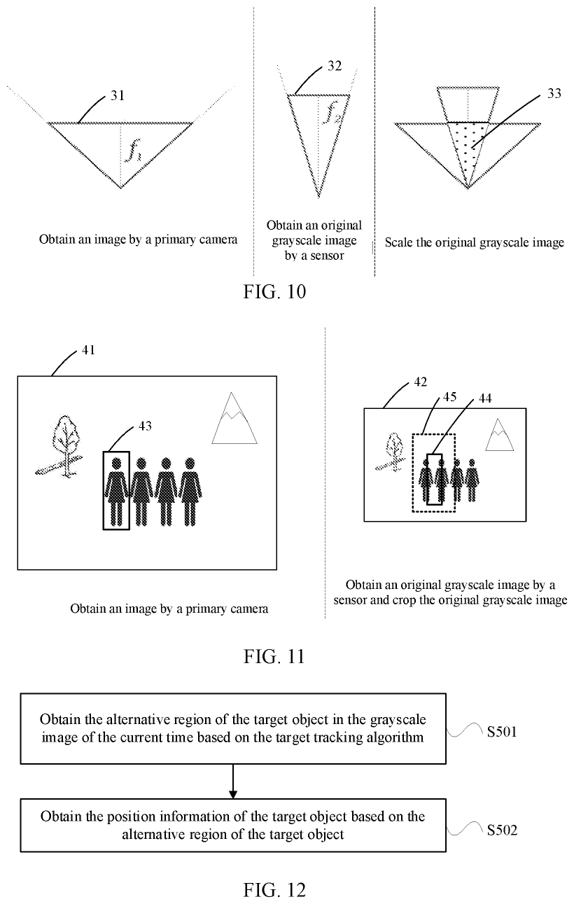

FIG. 10 is a schematic diagram showing scaling images based on the focal length according to the example embodiment shown in FIG. 7. Referring to FIG. 10, the left side shows an image 31 obtained by the primary camera, with a focal length of f1. The center shows an original grayscale image 32 obtained by the sensor, with a focal length of f2. Because the primary camera and the sensor have different focal lengths and different other parameters, the field of view and the size of the imaging surface are also different. The right side shows that an image 33 formed by scaling the original grayscale image based on the scaling factor. In some embodiments, the scaling factor is f1/f2.

Scaling the original grayscale image based on the scaling factor eliminates the change in the size of objects in the corresponding image caused by the different focal lengths of the image and the original grayscale image, thereby improving the accuracy of the target detection.

The present disclosure does not limit the execution order of cropping the image based on the image aspect ratio and scaling the image based on the focal length, which can be configured as needed. In addition, the present disclosure does not limit whether cropping the image based on the image aspect ratio or scaling the image based on the scaling factor needs to be executed, which can be determined as needed.

In some embodiments, obtaining the projection candidate region corresponding to the reference candidate region based on the reference candidate region and the original grayscale image includes: based on rotation relationship between the primary camera and the sensor, projecting the center point of the reference candidate region to the original grayscale image to obtain a projection center point; and based on the projection center point, obtaining the projection candidate region in the original grayscale image based on a pre-set rule.

The present disclosure does not limit the pre-set rule, which can be configured as needed. In some embodiments, the pre-set rule includes scaling the size of the reference candidate region based on a pre-set factor to obtain the size of the projection candidate region. The present disclosure does not limit the pre-set factor, which can be configured as needed. In some embodiments, the pre-set rule includes determining the size of the projection candidate region based on the resolution of the image obtained by the primary camera and the resolution of the grayscale image obtained by the sensor. In some embodiments, the pre-set factor is one, that is, no scaling operation is performed. Alternatively, the pre-set rule may be reducing as compared to enlarging.

In some embodiments, taking the projection center point as the center and obtaining the projection candidate region in the original grayscale image based the pre-set rule include: based on the resolution of the image and the resolution of the original grayscale image, determining a change coefficient; based on the change coefficient and the size of the reference candidate region, obtaining the size of the to-be-processed region in the original grayscale image corresponding to the reference candidate region; and determining the region formed by enlarging the to-be-processed region based on the pre-set factor to be the projection candidate region.

The present disclosure does not limit the value of the pre-set factor, which can be configured as needed.

In some embodiments, if the process of cropping the image based on the image aspect ratio and the process of the scaling the image based the focal length are performed to the original grayscale image, the original grayscale image essentially becomes the cropped and scaled grayscale image.

FIG. 11 is a schematic diagram of obtaining a projection candidate region corresponding to a reference candidate region according to the example embodiment shown in FIG. 7. Referring to FIG. 11, the left side shows an image 41 obtained by the primary camera, with an image aspect ratio of 16:9, and pixels of 1920*1080. The image 41 includes the reference candidate region 43 of the target object. On the right side, the original grayscale image is obtained by the sensor, and the process of cropping the image based on the image aspect ratio and the process of scaling the image based on the focal length are performed to form a changed grayscale image 42. The changed grayscale image 42 has the image aspect ratio of 16:9 and the pixels of 640*360. The changed grayscale image 42 includes a to-be-processed region 44 and a projection candidate region 45.

First, based on the rotation relationship between the primary camera and the sensor, the center point (not shown) of the reference candidate region 43 is projected to the changed grayscale image 42 to obtain the projection center point (not shown).

In one example, the following equation is applied:

$$[ \begin{matrix}{u}_{gray} \\ {v}_{gray} \\ 1\end{matrix} ] {K}_{gray} {R}_{c g} {K}_{color}^{- 1} [ \begin{matrix}{u}_{color} \\ {v}_{color} \\ 1\end{matrix} ]$$

where [U_{gray} V_{gray} 1]^{T} represents the center point of the to-be-processed region 44 in the changed grayscale image 42, [u_{color} v_{color} 1]^{T} represents the center point of the reference candidate region 43 in the image 41, R_{cg} represents the rotation relationship between the primary camera and the sensor and can be further decomposed as R_{cg}=R_{ci}R_{Gi}⁻¹R_{cg}, R_{ci} represents the rotation relationship of the sensor with respect to the IMU of the body, i.e., a mounting angle of the sensor, such as the front view, the bottom view, and the rear view (fixed for each UAV and can be obtained from the drawings or the factory default setting), R_{Gi} represents the rotation relationship of the UAV in the geodetic coordinate system and can be obtained from the output of the IMU, R_{iG}=R_{Gi}⁻¹ is obtained by inverting R_{Gi}, and R_{Gg} represents the rotation relationship of the gimbal in the geodetic coordinate system and can be obtained from the output of the gimbal itself.

Then, the change coefficient is determined based on the resolution of the image 41 and the resolution of the changed grayscale image 42. In one example, the resolution of the image 41 is 1920*1080 and the resolution of the changed grayscale image 42 is 640*360. The change coefficient is λ=1920/640=3.

And then, the size of the to-be-processed region 44 in the changed grayscale image 42 and corresponding to the reference candidate region 43 is obtained based on the change coefficient λ and the size of the reference candidate region. In one example, assuming that the width and height of the reference candidate region 43 are w and h, respectively. Then, the width and the height of the to-be-processed region 44 are w′=λ * w and h′=λ * h. It can be seen that a deviation occurs in the position of the to-be-processed region 44 in the changed grayscale image 42.

Finally, the to-be-processed region 44 is enlarged based on the pre-set factor to form the projection candidate region 45.

As such, the alternative region of the target object obtained by processing the projection candidate region 45 is more accurate. At the same time, the amount of calculation is reduced, and the resource utilization rate, and the speed and accuracy of the target detection are improved.

Various manners of obtaining the image of the current time by the primary camera and obtaining the alternative region of the target object based on the grayscale image of the current time may be applied to the embodiments of the present disclosure, as long as the process of applying the target tracking algorithm to obtain the alternative region of the target object based on the grayscale image of the current time is included.

In the target detection method provided by the present disclosure, when detecting the depth image based on the detection algorithm, the target tracking algorithm is also used to obtain the alternative region of the target object based on the grayscale at the current time. The position information of the target object is obtained based on at least one of the candidate region of the target object or the alternative region of the target object. Combining the results of both the detection algorithm and the target tracking algorithm eventually determines the position information of the target object and improves the accuracy of the position information of the target object.

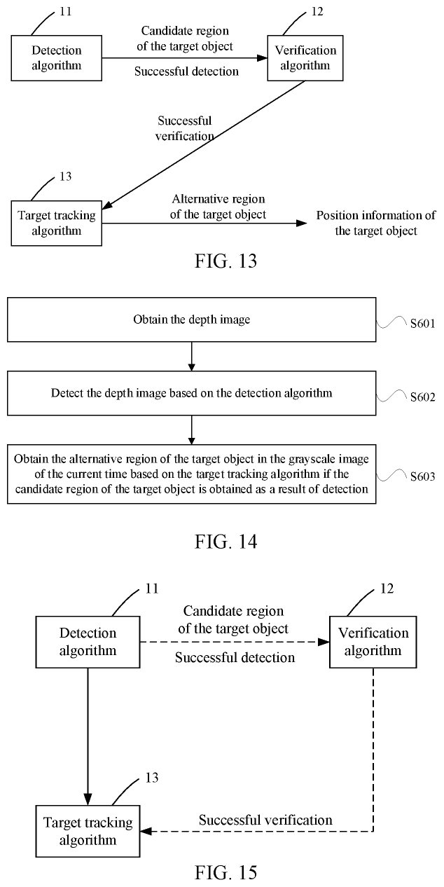

FIG. 12 is a flowchart of a target detection method according to another example embodiment of the present disclosure. FIG. 13 is a schematic diagram of an algorithm related to the method shown in FIG. 12. The present disclosure provides another example embodiment of the target detection method. When both the detection algorithm and the target tracking algorithm are performed, the target detection method provides additional process for determining the position information of the target object. As shown in FIG. 12 and FIG. 13, after S103, if the candidate region of the target object is determined to be the effective region of the target object based on the verification algorithm, the target detection method further includes: obtaining the alternative region of the target object in the grayscale image of the current time based on the target tracking algorithm (S501) and obtaining the position information of the target object based on the alternative region of the target object (S502), where the effective region of the target object is used as a reference region of the target object at the current time of the target tracking algorithm.

In one example, referring to FIG. 13, the target detection method involves the detection algorithm 11, the verification algorithm 12, and the target tracking algorithm 13. Both the target tracking algorithm and the detection algorithm are performed. The grayscale image of the current time is proceeded based on the target tracking algorithm to obtain the processing result. The processing result includes the alternative region of the target object. The depth image is processed based on the detection algorithm to obtain the detection result. The detection result includes the candidate region of the target object. Moreover, the candidate region of the target object is verified based on the verification algorithm to determine whether the candidate region of the target object is valid.

When the candidate region of the target object is determined to be the effective region of the target object based on the verification algorithm, the effective region of the target object is used as a reference target object at the current time of the target tracking algorithm to eliminate cumulative errors of the target tracking algorithm, thereby improving the accuracy of the target detection. Moreover, determining the position information of the target object based on the result of the target tracking algorithm improves the accuracy of the position information of the target object.

In some embodiments, after the position information of the target object is obtained based on the alternative region of the target object (S502), the target detection method further includes: controlling the UAV based on the position information of the target object.

In some embodiments, if the position information of the target object is the position information in the camera coordinate system, before controlling the UAV based on the position information of the target object, the target detection method further includes: converting the position information of the target object to the position information in the geodetic coordinate system.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

Because the operation principle is similar to the example embodiment shown in FIG. 4, the detailed description is omitted.

In some embodiments, before obtaining the position information of the target object based on the alternative region of the target object (S502), the target detection method further includes: determining whether the alternative region of the target object is valid based on the verification algorithm. Determining whether the alternative region of the target object is valid based on the verification algorithm further improves the accuracy of the target detection.

Because the operation principle is similar to the example embodiment shown in FIG. 7, the detailed description is omitted.

In some embodiments, the first frequency is greater than the second frequency. The first frequency is the frequency of obtaining the alternative region of the target object in the grayscale image of the current time based on the target tracking algorithm. The second frequency is the frequency of detecting the depth image based on the detection algorithm.

Because the operation principle is similar to the example embodiment shown in FIG. 5, the detailed description is omitted.

In some embodiments, obtaining the alternative region of the target object in the grayscale image of the current time based on the target tracking algorithm (S501) includes: obtaining the image of the current time by the primary camera; obtaining the original grayscale image by the sensor matching the image obtained by the primary camera; detecting the image obtained by the primary camera to obtain the reference candidate region of the target object; based on the reference candidate region and the original grayscale image, obtaining the projection candidate region corresponding to the reference candidate region; and based on the projection candidate region, obtaining the alternative region of the target object.

Because the operation principle is similar to the example embodiment shown in FIG. 7, the detailed description is omitted.

In the target detection method provided by the present disclosure, when detecting the depth image based on the detection algorithm, if the candidate region of the target object is determined to be the effective region of the target object based on the verification algorithm, the alternative region of the target object in the grayscale image of the current time is further obtained based on the target tracking algorithm. The effective region of the target object becomes the reference region of the target object at the current time of the target tracking algorithm. The position information of the target object is obtained based on the alternative region of the target object. Obtaining the valid result based on the verification algorithm corrects the target tracking algorithm, improves the accuracy of the target detection, and further improves the accuracy of determining the position information of the target object.

Further, the present disclosure provides another example embodiment of the target detection algorithm for obtaining the position information of the target object. After the position information of the target object is obtained, the position information of the target object is corrected to further improve the accuracy of the position information of the target object. After the position information of the target object is obtained, the target detection method provided by the present disclosure further includes: correcting the position information of the target object to obtain the corrected position information of the target object. Correcting the position information of the target object improves the accuracy of determining the position information of the target object.

In some embodiments, correcting the position information of the target object to obtain the corrected position information of the target object includes: obtaining an estimated position information of the target object at the current time based on a pre-set movement model; and based on the estimated position information and the position information of the target object, obtaining the corrected position information of the target object based on Kalman filter algorithm.

The present disclosure does not limit the selection of the pre-set movement model, which can be configured as needed. In some embodiments, the pre-set movement model is the constant speed movement model. In some other embodiments, the pre-set movement model is the movement model generated in advance based on known data in the process of UAV gesture control.

In some embodiments, before applying Kalman filter algorithm to the estimated position information and the position information of the target object to obtain the corrected position information of the target object, the target detection method further includes: converting the position information of the target object to the position information in the geodetic coordinate system.

Because the operation principle is similar to the example embodiment shown in FIG. 4, the detailed description is omitted.

In one example, assuming that the target object is the hand of the person and air resistance is ignored. At the initialization, the hand is at a fixed position. The position of the hand is measured every Δt seconds (i.e., an interval time of the target tracking algorithm). However, the measurement is not accurate. Thus, a model of the position and the speed is established.

Because the interval time of the observation or measurement is short, the simplest constant speed movement model is directly applied. The position and the speed of the hand are described in a linear state space by the following equation:

$${X}_{k} = [ \begin{matrix}X \\ \dot{X}\end{matrix} ]$$

where X represents the position, and \dot{X} represents the speed, i.e., the derivative of the position with respect to time.

Assuming that between the time k−-1 and the time k, the acceleration of the hand is aₖ, which conforms to a normal distribution with the mean equal to zero and the standard deviation equal to σₐ. According to Newton's law of motion, the following is obtained:

$${a}_{k} ∼ N ( 0 , {σ}_{a} )$$

$${X}_{k} = F {x}_{k - 1} + G {a}_{k}$$

$$where F = [ \begin{matrix}1 & Δ t \\ 0 & 1\end{matrix} ] , G = [ \begin{matrix}Δ {t}^{2} / 2 \\ Δ t\end{matrix} ]$$

$$then , \\ Q = cov ( Ga ) = E [ ( G a ) {( G a )}^{T} ] = G E [ {a}^{2} ] {G}^{T} = {σ}_{a}^{2} G {G}^{T}$$

The position is observed or measured at each time. The measurement is interfered by a noise. Assuming that the noise conforms to Gaussian distribution, there are:

Vₖ˜N(0, σ_{V}), Wₖ˜N(0, σₖ)

Zₖ₁=H₁Xₖ+Vₖ

Zₖ₂=H₂Xₖ+Wₖ

Two measurements are described here, which are the point on the 2D image (the center of the region of the hand) and the depth information of the point on the 3D depth image (the depth of the center of the region of the hand), respectively. The measurement models of both measurements are given below:

$$[ \begin{matrix}U \\ V\end{matrix} ] = K [ {R}_{cw} ( {}_{}^{w}{P}{}_{hand}^{} - {}_{}^{w}{P}{}_{camera}^{} ) ] + {V}_{k} = K [ {R}_{ci} {R}_{iw} ( {}_{}^{w}{P}{}_{hand}^{} - ( {}_{}^{w}{P}{}_{imu}^{} + {R}_{wi} \cdot {t}_{c}^{i} ) ) ] + {V}_{k}$$

$$depth = {[ {R}_{cw} ( {}_{}^{w}{P}{}_{hand}^{} - {}_{}^{w}{P}{}_{camera}^{} ) ]}^{( 3 )} + {W}_{k} = {[ {R}_{ci} {R}_{iw} ( {}_{}^{w}{P}{}_{hand}^{} - ( {}_{}^{w}{P}{}_{imu}^{} + {R}_{wi} \cdot {t}_{c}^{i} ) ) ]}^{( 3 )} + {W}_{k}$$

At the initialization, that is, when the position of the hand is detected for the first time, an average of three consecutive measurements is configured as the initial value of the position T₀. And, when starting the initialization, the speed is zero, that is, the hand is stationary, as described by the equation below:

$${\hat{X}}_{0 \vert 0} = [ \begin{matrix}{T}_{0} \\ 0\end{matrix} ]$$

For the covariance matrix, a matrix whose diagonal elements are B can be initialized. B can be configured as needed, and will gradually converge during the calculation process. If B is relatively large, the initial measurement tends to be used subsequently for a short period of time. If B is relatively small, the subsequent measurements tend to be used instead after a short period of time. It can be described in the equation below:

$${P}_{0 \vert 0} = [ \begin{matrix}B & 0 \\ 0 & B\end{matrix} ]$$

Therefore, relatively stable observations or measurements can be obtained by applying Kalman filter algorithm. Here, [U, V]^{T} is the position of the center of the region of the hand in the grayscale image, and depth is the depth of the hand.

In some embodiments, the target detection method provided by the present disclosure further includes: determining the corrected position information of the target object to be the reference position information of the target object for the subsequent measurement time of the target tracking algorithm.

In one example, the corrected position information of the target object is determined to be the reference position information of the target object for the subsequent measurement time of the target tracking algorithm, thereby eliminating the accumulated errors of the target tracking algorithm and improving the accuracy of the target detection.

In the target detection method provided by the present disclosure, after the position information of the target object is obtained, the position information of the target object is corrected to obtain the corrected position information of the target object, thereby further improving the accuracy of determining the position information of the target object.

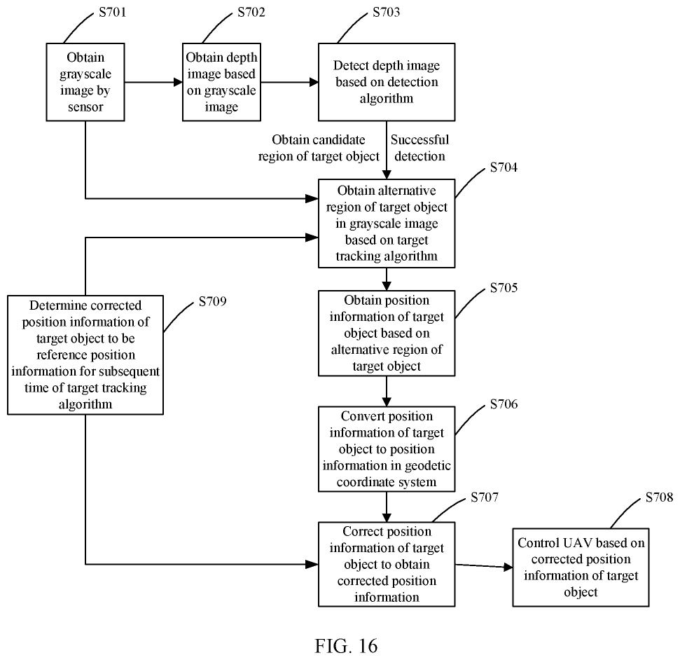

FIG. 14 is a flowchart of a target detection method according to another example embodiment of the present disclosure. FIG. 15 is a schematic diagram of an algorithm related to the method shown in FIG. 14. The present disclosure provides another example embodiment of the target detection method, which is performed by a target detection apparatus. The target detection apparatus can be disposed at the UAV. As shown in FIG. 14 and FIG. 15, the target detection method includes: obtaining a depth image (S601); and detecting the depth image based on a detection algorithm (S602).

In one example, the UAV detects the image photographed by the image collector to recognize the target object and then to control the UAV. In some embodiments, the type of the image collector may be different, and correspondingly the way of obtaining the depth image may be different.

In some embodiments, obtaining the depth image includes: obtaining the grayscale image by the sensor; and obtaining the depth image based on the grayscale image.

In some embodiments, the sensor directly obtains the depth image.

In some embodiments, obtaining the depth image includes: obtaining the image by the primary camera and obtaining the original grayscale image by the sensor matching the image obtained by the primary camera; detecting the image based on the detection algorithm to obtain the reference candidate region of the target object; and based on the reference candidate region and the original grayscale image, obtaining the depth image in the original grayscale image corresponding to the reference candidate region.

Because the operation principle is similar to the example embodiment shown in FIG. 2, the detailed description is omitted.

At S603, if the candidate region is obtained by the target detection, the alternative region of the target object in the grayscale image of the current time is obtained based on the target tracking algorithm.

The candidate region of the target object becomes the reference region of the target object at the current time of the target tracking algorithm.

In one example, referring to FIG. 15, the target detection method involves the detection algorithm 11 and the target tracking algorithm 13. The degree of coupling between two adjacent detections of the detection algorithm is low, and hence the accuracy of detection is high. The degree of coupling between two adjacent results of the target tracking algorithm is high and the tracking is a recursive process, hence errors may accumulate and the accuracy may become lower and lower over time. In some embodiments, detecting the depth image based on the detection algorithm obtains one of two detection results. If the detection is successful, the candidate region of the target object is obtained. If the detection is unsuccessful, no target object is recognized. If the candidate region of the target object is obtained by detecting the depth image based on the detection algorithm, the candidate region of the target object becomes the reference region of the target object at the current time of the target tracking algorithm, and the reference of the target tracking algorithm is corrected, thereby improving the accuracy of the target tracking algorithm. Thus, the accuracy of the target detection is improved.

The candidate region of the target object refers to a region in the grayscale image. The grayscale image corresponds to the depth image. The region in the grayscale image corresponds to a region in the depth image determined based on the detection algorithm and including the target object. The candidate region of the target object includes the 2D scene information. The determined region in the depth image including the target object determined includes the 3D scene information.

In the target detection method provided by the present disclosure, the 3D depth image based detection algorithm and the 2D image based target tracking algorithm are combined. The detection result of the detection algorithm is used to correct the target tracking algorithm, thereby improving the accuracy of the target detection.

In some embodiments, the target object includes any one of: the head, the upper arm, the torso, and the hand of the person.

The present disclosure does not limit the time relationship between the grayscale image of the current time and the depth image at S601.

In some embodiments, the first frequency is equal to the second frequency. In some other embodiments, the first frequency is greater than the second frequency. The first frequency is the frequency of obtaining the alternative region of the target object in the grayscale image of the current time based on the target tracking algorithm. The second frequency is the frequency of detecting the depth image based on the detection algorithm.

Because the operation principle is similar to the example embodiment shown in FIG. 5, the detailed description is omitted.

In some embodiments, the target detection algorithm provided by the present disclosure further includes: obtaining the position information of target object based on the alternative region of the target object; and controlling the UAV based on the position information of the target object.

In one example, the position information of the target object is the position information in the 3D coordinate system, and can be represented by the 3D coordinate (x, y, z). In some embodiments, the 3D coordinate is with reference to the camera. In some other embodiments, the 3D coordinate is with reference to the ground. In the geodetic coordinate system, the positive direction of the x-axis is north, the positive direction of the y-axis is east, and the positive direction of the z-axis is pointing to the center of the Earth. After the position information of the target object is obtained, the flight of the UAV is controlled based on the position information of the target object. For example, the flight altitude, the flight direction, and the flight mode (flying in a straight line or in a circle) of the UAV may be controlled.

Controlling the UAV based on the position information of the target object reduces the complexity of controlling the UAV and improves the user experience.

In some embodiments, the alternative region of the target object is the region in the grayscale image of the current time including the target object, and obtaining the position information of the target object based on the alternative region of the target object includes: obtaining the depth image corresponding to the grayscale image of the current time; determining the region in the depth image corresponding to the alternative region of the target object based on the alternative region of the target object; and obtaining the position information of the target object based on the region in the depth image corresponding to the alternative region of the target object.

In some embodiments, before controlling the UAV based on the position information of the target object, the target detection method further includes: converting the position information of the target object to the position information in the geodetic coordinate system.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

Because the operation principle is similar to the example embodiment shown in FIG. 4, the detailed description is omitted.

In some embodiments, before obtaining the alternative region of the target object in the grayscale image of the current time based on the target tracking algorithm at S603, the target detection method further includes: determining whether the candidate region of the target object is the effective region of the target object based on the verification algorithm; if the candidate region of the target object is determined to be the effective region of the target object, performing the process of obtaining the alternative region of the target object in the grayscale image of the current time based on the target tracking algorithm at S603.

In one example, referring to FIG. 15, the target detection method involves the detection algorithm 11, the verification algorithm 12, and the target tracking algorithm 13. The depth image is detected based on the detection algorithm to obtain the candidate region of the target object. However, the detection result of the detection algorithm may not be accurate, especially when the size of the target object is small and the shape of the target object is complicated. For example, the hand of the person is detected. Hence, the candidate region of the target object is further verified based on the verification algorithm to determine whether candidate region of the target object is valid. When the candidate region of the target object is valid, the candidate region of the target object becomes the effective region of the target object. When the candidate region of the target object is determined to be the effective region based on the verification algorithm, the effective region of the target object becomes the reference region of the target object at the current time of the target tracking algorithm, thereby further improving the accuracy of the target tracking algorithm and improving the accuracy of the target detection.

The present disclosure does not limit the implementation of the verification algorithm, which can be configured as needed. In some embodiments, the verification algorithm may be the convolutional neural network (CNN) algorithm. In some other embodiments, the verification algorithm may be the template matching algorithm.

In some embodiments, after S601 is performed, no candidate region of the target object is obtained after the detection process, the target detection method further includes: obtaining the alternative region of the target object in the grayscale image of the current time based on the target tracking algorithm; and determining whether the alternative region of the target object is the effective region of the target object based on the verification algorithm.

In some embodiments, obtaining the alternative region of the target object in the grayscale image of the current time includes: obtaining the alternative region of the target object based on the reference region of the target object and the grayscale image of the current time. The reference region of the target object includes any one of the following: the effective region of the target object determined based on the verification algorithm, the candidate region of the target object determined based on the detection algorithm by detecting the depth image, and the alternative region of the target object determined based on the target tracking algorithm.

In some embodiments, the target detection method provided by the present disclosure further includes: if the alternative region of the target object is the effective region of the target object, obtaining the position information of the target object based on the effective region of the target object.

Because the operation principle is similar to the example embodiment shown in FIG. 5, the detailed description is omitted.

In some embodiments, obtaining the alternative region of the target object in the grayscale image of the current time based on the target tracking algorithm includes: obtaining the image of the current time by the primary camera; obtaining the original grayscale image by the sensor matching the image obtained by the primary camera; detecting the image obtained by the primary camera to obtain the reference candidate region of the target object; based on the reference candidate region and the original grayscale image, obtaining the projection candidate region corresponding to the reference candidate region; and based on the projection candidate region, obtaining the alternative region of the target object.

In some embodiments, obtaining the original grayscale image by the sensor matching the image obtained by the primary camera includes: determining the grayscale image having the smallest time stamp difference with the image to be the original grayscale image.

In some embodiments, determining the grayscale image having the smallest time stamp difference with the image to be the original grayscale image includes: obtaining the time stamp of the image and the time stamp of at least one grayscale image within a certain time range of the time stamp of the image; calculating the difference between the time stamp of the image and the time stamp of the at least one grayscale image; and if the smallest of the at least one difference is smaller than the pre-set threshold, determining the grayscale image corresponding to the smallest difference to be the original grayscale image.

In some embodiments, the mid-photographing time is considered as the time stamp of the image.

In some embodiments, after the original grayscale image is obtained by the sensor matching the image obtained by the primary camera, the target detection method further includes: if the image aspect ratio of the image is different from the image aspect ratio of the original grayscale image, the original grayscale image is cropped based on the image aspect ratio of the image.

In some embodiments, after the original grayscale image matching the image is obtained by the sensor, the target detection method further includes: determining the scaling factor based on the focal length of the image and the focal length of the original grayscale image; and scaling the original grayscale image based on the scaling factor.

In some embodiments, obtaining the projection candidate region corresponding to the reference candidate region based on the reference candidate region and the original grayscale image includes: based on the rotation relationship between the primary camera and the sensor, projecting the center point of the reference candidate region to the original grayscale image to obtain the projection center point; and based on the projection center point, obtaining the projection candidate region in the original grayscale image based on the pre-set rule.

In some embodiments, taking the projection center point as the center and obtaining the projection candidate region in the original grayscale image based the pre-set rule include: based on the resolution of the image and the resolution of the original grayscale image, determining the change coefficient; based on the change coefficient and the size of the reference candidate region, obtaining the size of the to-be-processed region in the original grayscale image corresponding to the reference candidate region; and determining the region formed by enlarging the to-be-processed region based on the pre-set factor to be the projection candidate region.

The present disclosure does not limit the value of the pre-set factor, which can be configured as needed.

Because the operation principle is similar to the example embodiment shown in FIG. 7, the detailed description is omitted.

In some embodiments, after the position information of the target object is obtained, the target detection method provided by the present disclosure further includes: correcting the position information of the target object to obtain the corrected position information of the target object.

In some embodiments, correcting the position information of the target object to obtain the corrected position information of the target object includes: obtaining the estimated position information of the target object at the current time based on the pre-set movement model; and based on the estimated position information and the position information of the target object, obtaining the corrected position information of the target object based on Kalman filter algorithm.

In some embodiments, before applying Kalman filter algorithm to the estimated position information and the position information of the target object to obtain the corrected position information of the target object, the target detection method further includes: converting the position information of the target object to the position information in the geodetic coordinate system.

In some embodiments, the target detection method provided by the present disclosure further includes: determining the corrected position information of the target object to be the reference position information of the target object for the subsequent measurement time of the target tracking algorithm.

Because the operation principle is similar to the example embodiments described above, the detailed description is omitted.

In the embodiments of the present disclosure, the concepts such as the detection algorithm, the target tracking algorithm, the verification algorithm, the target object, the alternative region of the target object, the effective region of the target object, the reference region of the target object, the primary camera, the sensor, the depth image, the image obtained by the primary camera, the grayscale image obtained by the sensor, the original grayscale image, the reference candidate region of the target object, the position information of the target object, and the corrected position information of the target object are involved. Because the operation principle is similar to the example embodiments described above, the detailed description is omitted.

The following is an example for illustrating the implementation of the target detection method. In some embodiments, the target object is a human body, and more specifically, the head, the upper arm, or the torso of the person.

FIG. 16 is a flowchart of an implementation of the target detection method according to the example embodiment shown in FIG. 14. As shown in FIG. 16, the target detection method includes the following processes.

At S701, the grayscale image is obtained by the sensor.

At S702, the depth image is obtained based on the grayscale image.

At S703, the depth image is detected based on the detection algorithm. In some embodiments, the successful detection results in obtaining the candidate region of the target object.

At S704, the alternative region of the target object in the grayscale image is obtained based on the target tracking algorithm. The candidate region of the target object becomes the reference region of the target object at the current time of the target tracking algorithm.

At S705, the position information of the target object is obtained based on the alternative region of the target object. In one example, the position information of the target object is the position information in the camera coordinate system.

At S706, the position information of the target object is converted to the position information in the geodetic coordinate system.

At S707, the position information of the target object is corrected to obtain the corrected position information of the target object.

At S708, the UAV is controlled based on the corrected position information of the target object.

At S709, the corrected position information is determined to be the reference position information for the subsequent measurement time of the target tracking algorithm.

Generally, for the human body, the detection result obtained by detecting the depth image based on the detection algorithm is relatively accurate. Thus, the detection result is directly used as the reference region of the target object of the target tracking algorithm to correct the target tracking algorithm, thereby improving the accuracy of the target detection.

The following is another example for illustrating the implementation of the target detection method. In some embodiments, the target object is the hand of the person.

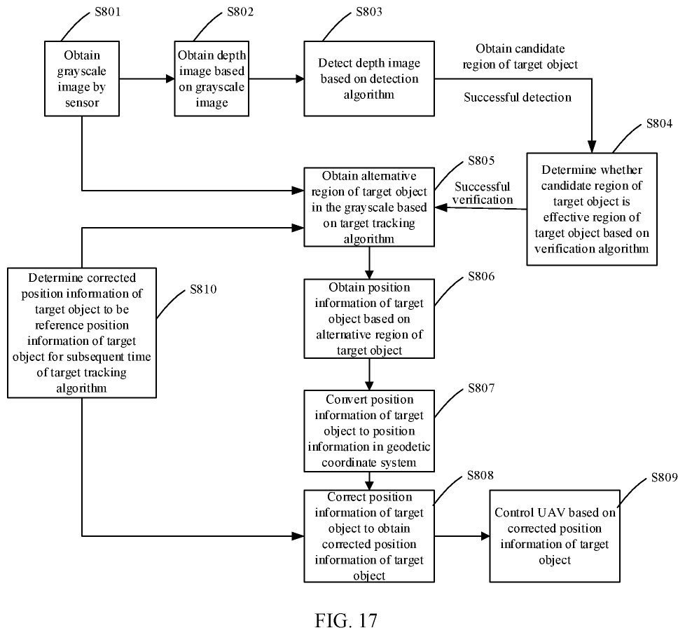

FIG. 17 is a flowchart of another implementation of the target detection method according to the example embodiment shown in FIG. 14. As shown in FIG. 17, the target detection method includes the following processes.

At S801, the grayscale image is obtained by the sensor.

At S802, the depth image is obtained based on the grayscale image.

At S803, the depth image is detected based on the detection algorithm. In some embodiments, the successful detection results in obtaining the candidate region of the target object.

At S804, whether the candidate region of the target object is the effective region of the target object is determined based on the verification algorithm. In some embodiments, the successful verification results in determining the candidate region of the target object to be the effective region of the target object.

At S805, the alternative region of the target object in the grayscale image is obtained based on the target tracking algorithm. The effective region of the target object becomes the reference region of the target object at the current time of the target tracking algorithm.

At S806, the position information of the target object is obtained based on the alternative region of the target object. In one example, the position information of the target object is the position information in the camera coordinate system.

At S807, the position information of the target object is converted to the position information in the geodetic coordinate system.

At S808, the position information of the target object is corrected to obtain the corrected position information of the target object.

At S809, the UAV is controlled based on the corrected position information of the target object.

At S810, the corrected position information is determined to be the reference position information for the subsequent measurement time of the target tracking algorithm.

Because the hand of the person is relatively small, to improve the accuracy of the target detection, after the detection result is obtained by detecting the depth image based on the detection algorithm, whether the detection result is accurate is further determined based on the verification algorithm. The verified effective region of the target object becomes the reference region of the target object of the target tracking algorithm to correct the target tracking algorithm, thereby improving the accuracy of the target detection.

The following is another example for illustrating the implementation of the target detection method. In some embodiments, the target object is the hand of the person.

FIG. 18 is a flowchart of another implementation of the target detection method according to the example embodiment shown in FIG. 14. As shown in FIG. 18, the target detection method includes the following processes.

At S901, the grayscale image is obtained by the sensor.

At S902, the depth image is obtained based on the grayscale image.

At S903, the depth image is detected based on the detection algorithm. In some embodiments, the unsuccessful detection does not result in obtaining the candidate region of the target object.

At S904, the alternative region of the target object in the grayscale image is obtained based on the target tracking algorithm. The reference region of the target object at the current time of the target tracking algorithm is the lats obtained result of the target tracking algorithm, that is, the alternative region of the target object in the grayscale image last obtained based on the target tracking algorithm.

At S905, whether the alternative region of the target object is the effective region of the target object is determined based on the verification algorithm. In some embodiments, the successful verification results in determining the alternative region of the target object to be the effective region of the target object.

At S906, the position information of the target object is obtained based on the alternative region of the target object. In one example, the position information of the target object is the position information in the camera coordinate system.

At S907, the position information of the target object is converted to the position information in the geodetic coordinate system.

At S908, the position information of the target object is corrected to obtain the corrected position information of the target object.

At S909, the UAV is controlled based on the corrected position information of the target object.

At S910, the corrected position information is determined to be the reference position information for the subsequent measurement time of the target tracking algorithm.

When detecting the depth image based on the detection algorithm fails, the result of the target tracking algorithm is obtained. Because the accumulated errors occur in the target tracking algorithm, whether the result of the target tracking algorithm is accurate is determined based on the verification algorithm, thereby improving the accuracy of the target detection.

The present disclosure provides the target detection method. The method includes: obtaining the depth image; detecting the depth image based on the detection algorithm; and if the candidate region of the target object is obtained as a result of the detection, obtaining the alternative region of the target object in the grayscale image of the current time based on the target tracking algorithm. The candidate region of the target object becomes the reference region of the target object at the current time of the target tracking algorithm. The target detection method provided by the embodiments of the present disclosure combines the 3D depth image based detection algorithm and the 2D image based target tracking algorithm, and corrects the target tracking algorithm through the detection result of the detection algorithm, thereby improving the accuracy of the target detection.

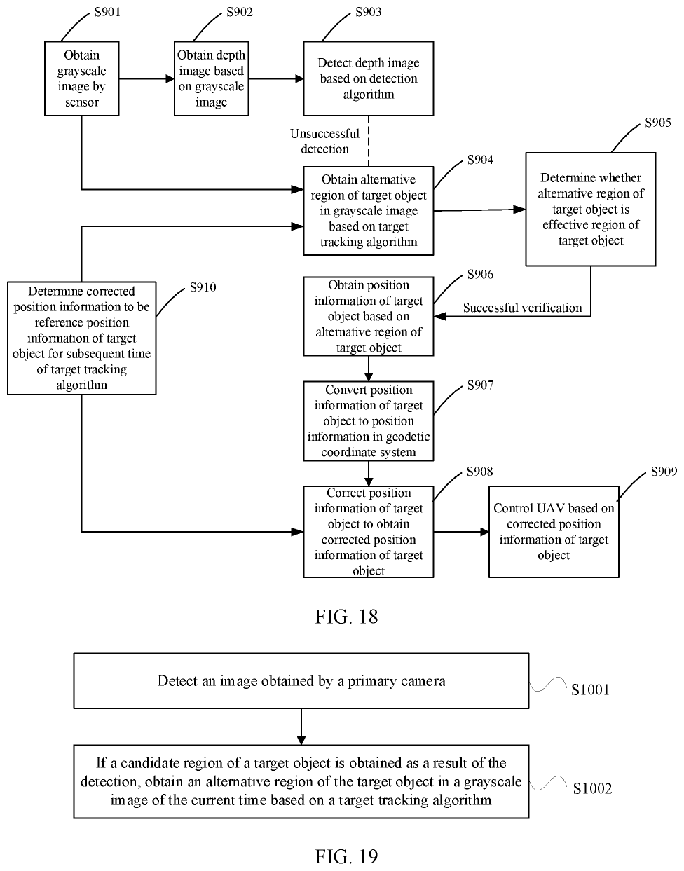

FIG. 19 is a flowchart of a target detection method according to another example embodiment of the present disclosure. The present disclosure provides another example embodiment of the target detection method, which is performed by the target detection apparatus. The target detection apparatus is disposed in the UAV. As shown in FIG. 19, the target detection method includes: obtaining the image by the primary camera (S1001); and if the candidate region of the target object is obtained as a result of the detection, obtaining the alternative region of the target object in the grayscale image of the current time based on the target tracking algorithm (S1002). The candidate region of the target object becomes the reference region of the target object at the current time of the target tracking algorithm.

In one example, the image obtained by the primary camera often has a higher resolution. Performing the detection algorithm on the image obtained by the primary camera often produces the more accurate detection result. The detection result is the candidate region including the target object. If the candidate region of the target object is obtained by detecting the image obtained by the primary camera, the candidate region of the target object becomes the reference region of the target object at the current time of the target tracking algorithm, and the reference of the target tracking algorithm is corrected, thereby improving the accuracy of the target tracking algorithm, and improving the accuracy of the target detection.

The present disclosure does not limit the image obtained by the primary camera. For example, the image obtained by the primary camera can be the color RGB image.

The present disclosure does not limit the algorithm for detecting the image obtained by the primary camera. For example, the algorithm can be the detection algorithm.

The candidate region of the target object refers to a region in the grayscale image. The grayscale image corresponds to the image obtained by the primary camera. The region in the grayscale image corresponds to a region determined by detecting the image obtained by the primary camera to include the target object. The candidate region of the target object includes the 2D scene information. The depth image is obtained based on the grayscale image or the image obtained by the primary camera. The depth image includes the 3D scene information.

The target detection method provided by the embodiments of the present disclosure combines the result of detecting the high resolution image obtained by the primary camera and the 2D image based target tracking algorithm, and corrects the target tracking algorithm, thereby improving the accuracy of the target detection.

In some embodiments, the target object may be any one of the head, the upper arm, the torso, and the hand of a person.

The present disclosure does not limit the time relationship between the grayscale image of the current time and the image obtained by the primary camera at S1001.

In some embodiments, the first frequency is greater than a third frequency. The first frequency is the frequency of obtaining the alternative region of the target object in the grayscale image of the current time based on the target tracking algorithm. The third frequency is the frequency of detecting the image obtained by the primary camera.

In some embodiments, the image is obtained by the primary camera at S1001 before the grayscale image of the current time is obtained. It is suitable for mobile device such as the UAV where the computing resources are limited. For example, at the current time, the candidate region of the target object in the image obtained by the primary camera is obtained, and the alternative region of the target object in the grayscale image is obtained. Because the frequencies of obtaining both are different, at the succeeding times, only the alternative region of the target object in the grayscale image is obtained, or only the candidate region of the target object in the image obtained by the primary camera is obtained. In some embodiments, when the candidate region of the target object in the image obtained by the primary camera is obtained, the process of obtaining the alternative region of the target object in the grayscale image can be turned off to reduce resource consumption.

In some embodiments, the first frequency is equal to the third frequency. In some embodiments, the image obtained by the primary camera at S1001 corresponds to the depth image obtained at the current time. Because the first frequency is equal to the third frequency, the accuracy of the target detection is further improved.

In some embodiments, the target detection method provided by the present disclosure further includes: obtaining the position information of the target object based on the alternative region of the target object; and controlling the UAV based on the position information of the target object.

In one example, the position information of the target object is the position information in the 3D coordinate system, and can be represented by the 3D coordinate (x, y, z). In some embodiments, the 3D coordinate is with reference to the camera or in the camera coordinate system. In some other embodiments, the 3D coordinate is with reference to the ground or in the geodetic coordinate system. In the geodetic coordinate system, the positive direction of the x-axis is north, the positive direction of the y-axis is east, and the positive direction of the z-axis is pointing to the center of the Earth. After the position information of the target object is obtained, the flight of the UAV is controlled based on the position information of the target object. For example, the flight altitude, the flight direction, and the flight mode (flying in a straight line or in a circle) of the UAV may be controlled.

Controlling the UAV based on the position information of the target object reduces the complexity of controlling the UAV and improves the user experience.

In some embodiments, the alternative region of the target object is the region in the grayscale image of the current time including the target object, and obtaining the position information of the target object based on the alternative region of the target object includes: obtaining the depth image corresponding to the grayscale image of the current time; determining the region in the depth image corresponding to the alternative region of the target object based on the alternative region of the target object; and obtaining the position information of the target object based on the region in the depth image corresponding to the alternative region of the target object.

In some embodiments, before controlling the UAV based on the position information of the target object, the target detection method further includes: converting the position information of the target object to the position information in the geodetic coordinate system.

In some embodiments, converting the position information in the camera coordinate system to the position information in the geodetic coordinate system includes: obtaining position-attitude information of the UAV; and converting the position information in the camera coordinate system to the position information in the geodetic coordinate system based on the position-attitude information of the UAV.

Because the operation principle is similar to the example embodiment shown in FIG. 4, the detailed description is omitted.

In some embodiments, before obtaining the alternative region of the target object in the grayscale image of the current time based on the target tracking algorithm (S1002), the target detection method further includes: determining whether the candidate region of the target object is the effective region of the target object based on the verification algorithm; if the candidate region of the target object is determined to be the effective region of the target object, performing the process of obtaining the alternative region of the target object in the grayscale image of the current time based on the target tracking algorithm.

In one example, the image obtained by the primary camera is detected to obtain the candidate region of the target object. However, the detection result may be not accurate. Hence, the candidate region of the target object is further verified based on the verification algorithm to determine whether candidate region of the target object is valid. When the candidate region of the target object is valid, the candidate region of the target object becomes the effective region of the target object. When the candidate region of the target object is determined to be the effective region based on the verification algorithm, the effective region of the target object becomes the reference region of the target object at the current time of the target tracking algorithm, thereby further improving the accuracy of the target tracking algorithm and improving the accuracy of the target detection.

The present disclosure does not limit the implementation of the verification algorithm, which can be configured as needed. In some embodiments, the verification algorithm may be the convolutional neural network (CNN) algorithm. In some other embodiments, the verification algorithm may be the template matching algorithm.

In some embodiments, after S1001 is performed, no candidate region of the target object is obtained, the target detection method further includes: obtaining the alternative region of the target object in the grayscale image of the current time based on the target tracking algorithm; and determining whether the alternative region of the target object is the effective region of the target object based on the verification algorithm.

In some embodiments, obtaining the alternative region of the target object in the grayscale image of the current time includes: obtaining the alternative region of the target object based on the reference region of the target object and the grayscale image of the current time. The reference region of the target object includes any one of the following: the effective region of the target object determined based on the verification algorithm, and the alternative region of the target object determined based on the target tracking algorithm.

In some embodiments, the target detection method provided by the present disclosure further includes: if the alternative region of the target object is the effective region of the target object, obtaining the position information of the target object based on the effective region of the target object.

Because the operation principle is similar to the example embodiment shown in FIG. 5, the detailed description is omitted.

In some embodiments, detecting the image obtained by the primary camera at the current time ay S1001 includes: obtaining the original grayscale image by the sensor matching the image obtained by the primary camera; detecting the image obtained by the primary camera to obtain the reference candidate region of the target object; based on the reference candidate region and the original grayscale image, obtaining the projection candidate region corresponding to the reference candidate region; and detecting the projection candidate region,.

The present disclosure does not limit the algorithm for detecting the projection candidate region. For example, the algorithm may be the target tracking algorithm.

In some embodiments, obtaining the original grayscale image by the sensor matching the image obtained by the primary camera includes: determining the grayscale image having the smallest time stamp difference with the image to be the original grayscale image.

In some embodiments, determining the grayscale image having the smallest time stamp difference with the image to be the original grayscale image includes: obtaining the time stamp of the image and the time stamp of at least one grayscale image within a certain time range of the time stamp of the image; calculating the difference between the time stamp of the image and the time stamp of the at least one grayscale image; and if the smallest of the at least one difference is smaller than the pre-set threshold, determining the grayscale image corresponding to the smallest difference to be the original grayscale image.

In some embodiments, the mid-photographing time is considered as the time stamp of the image.

In some embodiments, after the original grayscale image is obtained by the sensor matching the image obtained by the primary camera, the target detection method further includes: if the image aspect ratio of the image is different from the image aspect ratio of the original grayscale image, the original grayscale image is cropped based on the image aspect ratio of the image.

In some embodiments, after the original grayscale image matching the image is obtained by the sensor, the target detection method further includes: determining the scaling factor based on the focal length of the image and the focal length of the original grayscale image; and scaling the original grayscale image based on the scaling factor.

In some embodiments, obtaining the projection candidate region corresponding to the reference candidate region based on the reference candidate region and the original grayscale image includes: based on the rotation relationship between the primary camera and the sensor, projecting the center point of the reference candidate region to the original grayscale image to obtain the projection center point; and based on the projection center point, obtaining the projection candidate region in the original grayscale image based on the pre-set rule.

In some embodiments, taking the projection center point as the center and obtaining the projection candidate region in the original grayscale image based the pre-set rule include: based on the resolution of the image and the resolution of the original grayscale image, determining the change coefficient; based on the change coefficient and the size of the reference candidate region, obtaining the size of the to-be-processed region in the original grayscale image corresponding to the reference candidate region; and determining the region formed by enlarging the to-be-processed region based on the pre-set factor to be the projection candidate region.

Because the operation principle is similar to the example embodiment shown in FIG. 7, the detailed description is omitted.

In some embodiments, after the position information of the target object is obtained, the target detection method provided by the present disclosure further includes: correcting the position information of the target object to obtain the corrected position information of the target object.

In some embodiments, correcting the position information of the target object to obtain the corrected position information of the target object includes: obtaining the estimated position information of the target object at the current time based on the pre-set movement model; and based on the estimated position information and the position information of the target object, obtaining the corrected position information of the target object based on Kalman filter algorithm.

In some embodiments, before applying Kalman filter algorithm to the estimated position information and the position information of the target object to obtain the corrected position information of the target object, the target detection method further includes: converting the position information of the target object to the position information in the geodetic coordinate system.

In some embodiments, the target detection method provided by the present disclosure further includes: determining the corrected position information of the target object to be the reference position information of the target object for the subsequent measurement time of the target tracking algorithm.

Because the operation principle is similar to the example embodiments described above, the detailed description is omitted.

In the embodiments of the present disclosure, the concepts such as the detection algorithm, the target tracking algorithm, the verification algorithm, the target object, the alternative region of the target object, the effective region of the target object, the reference region of the target object, the primary camera, the sensor, the depth image, the image obtained by the primary camera, the grayscale image obtained by the sensor, the original grayscale image, the reference candidate region of the target object, the position information of the target object, and the corrected position information of the target object are involved. Because the operation principle is similar to the example embodiments described above, the detailed description is omitted.

The following is an example for illustrating the implementation of the target detection method. In some embodiments, the target object is a human body, and more specifically, the head, the upper arm, or the torso of the person.

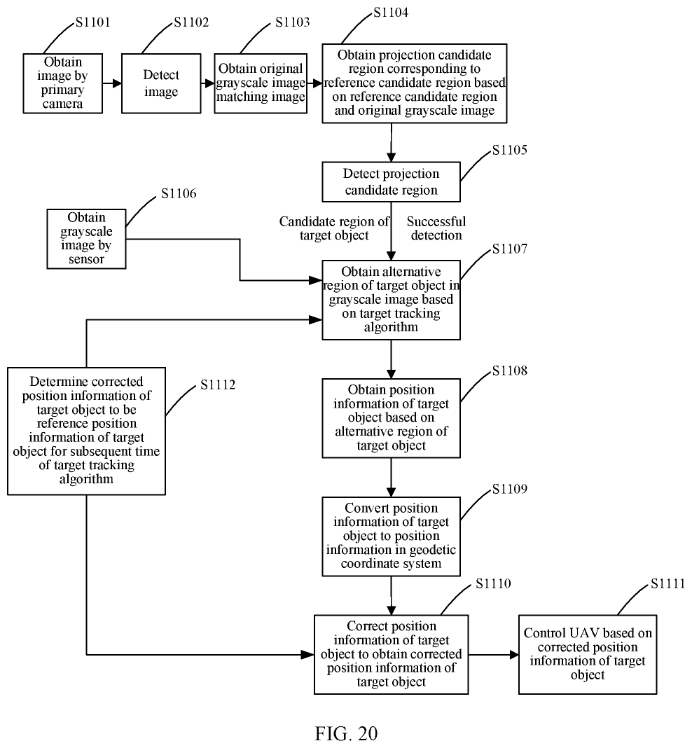

FIG. 20 is a flowchart of an implementation of the target detection method according to the example embodiment shown in FIG. 19. As shown in FIG. 20, the target detection method includes the following processes.

At S1101, the image is obtained by the primary camera.

At S1102, the image is detected. In some embodiments, the reference candidate region of the target object is obtained.

At S1103, the original grayscale matching the image is obtained. The original grayscale image is obtained by the sensor.

At S1104, the projection candidate region corresponding to the reference candidate region is obtained based on the reference candidate region and the original grayscale image.

At S1105, the projection candidate region is detected. In some embodiments, the candidate region of the target object is obtained.

At S1106, the grayscale image is obtained by the sensor.

At S1107, the alternative region of the target object in the grayscale image is obtained based on the target tracking algorithm. The candidate region of the target object obtained at S1105 becomes the reference region of the target object at the current time of the target tracking algorithm.

At S1108, the position information of the target object is obtained based on the alternative region of the target object. In one example, the position information of the target object is the position information in the camera coordinate system.

At S1109, the position information of the target object is converted to the position information in the geodetic coordinate system.

At S1110, the position information of the target object is corrected to obtain the corrected position information of the target object.

At S1111, the UAV is controlled based on the corrected position information of the target object.

At S1112, the corrected position information is determined to be the reference position information for the subsequent measurement time of the target tracking algorithm.

The following is another example for illustrating the implementation of the target detection method. In some embodiments, the target object is the hand of the person.

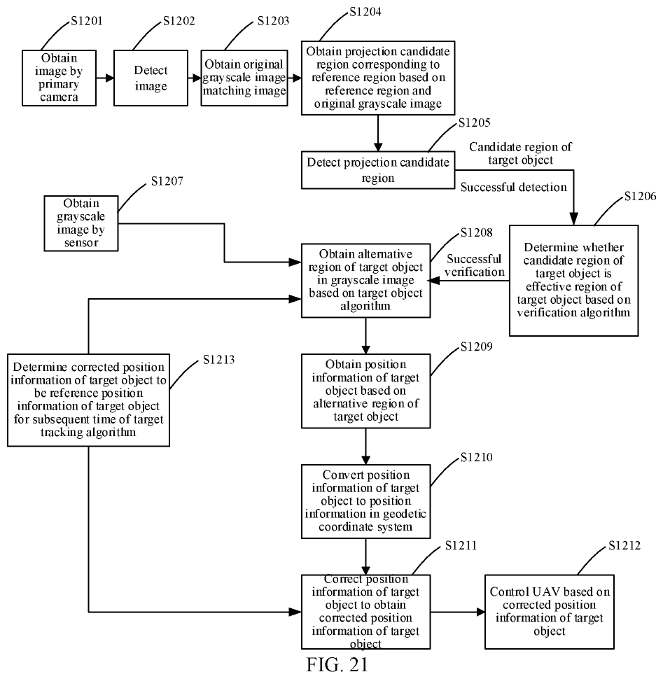

FIG. 21 is a flowchart of another implementation of the target detection method according to the example embodiment shown in FIG. 19. As shown in FIG. 21, the target detection method includes the following processes.

At S1201, the image is obtained by the primary camera.

At S1202, the image is detected. In some embodiments, the reference candidate region of the target object is obtained.

At S1203, the original grayscale matching the image is obtained. The original grayscale image is obtained by the sensor.

At S1204, the projection candidate region corresponding to the reference candidate region is obtained based on the reference candidate region and the original grayscale image.

At S1205, the projection candidate region is detected. In some embodiments, the candidate region of the target object is obtained.

At S1206, whether the candidate region of the target object is the effective region of the target object is determined based on the verification algorithm. In some embodiments, the verification is successful and the candidate region of the target object is determined to be the effective region of the target object.

At S1207, the grayscale image is obtained by the sensor.

At S1208, the alternative region of the target object in the grayscale image is obtained based on the target tracking algorithm. The effective region of the target object obtained becomes the reference region of the target object at the current time of the target tracking algorithm.

At S1209, the position information of the target object is obtained based on the alternative region of the target object. In one example, the position information of the target object is the position information in the camera coordinate system.

At S1210, the position information of the target object is converted to the position information in the geodetic coordinate system.

At S1211, the position information of the target object is corrected to obtain the corrected position information of the target object.

At S1212, the UAV is controlled based on the corrected position information of the target object.

At S1213, the corrected position information is determined to be the reference position information for the subsequent measurement time of the target tracking algorithm.

Because the hand of the person is relatively small, to improve the accuracy of the target detection, after the image obtained by the primary camera is detected to obtain the candidate region of the target object, whether the candidate region of the target object is valid is further determined based on the verification algorithm. The verified effective region of the target object becomes the reference region of the target object of the target tracking algorithm to correct the target tracking algorithm, thereby improving the accuracy of the target detection.

The following is another example for illustrating the implementation of the target detection method. In some embodiments, the target object is the hand of the person.

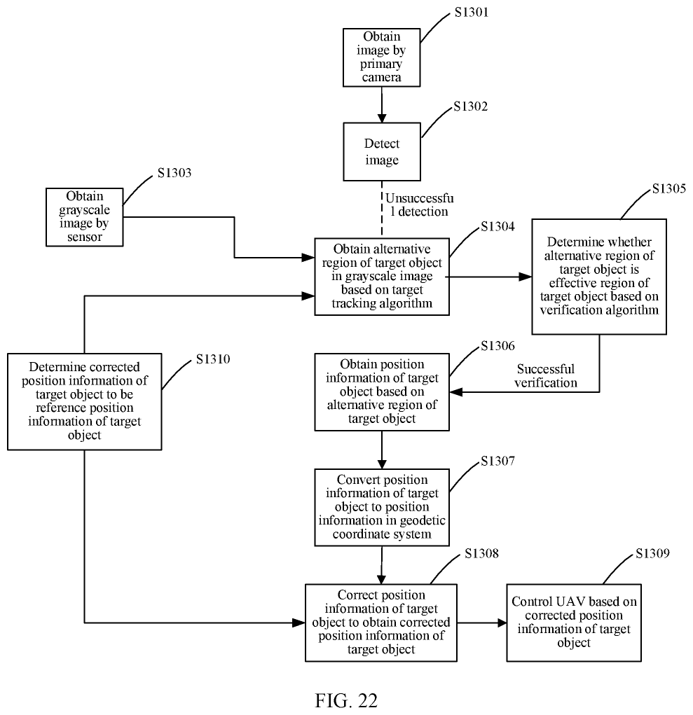

FIG. 22 is a flowchart of another implementation of the target detection method according to the example embodiment shown in FIG. 19. As shown in FIG. 22, the target detection method includes the following processes.

At S1301, the image is obtained by the primary camera.

At S1302, the image is detected. In some embodiments, detection is unsuccessful and no reference candidate region of the target object is obtained.

At S1303, the original grayscale image is obtained by the sensor.

At S1304, the alternative region of the target object in the grayscale image is obtained based the target tracking algorithm. The reference region of the target object at the current time of the target tracking algorithm is the last result of the target tracking algorithm, that is, the alternative region of the target object in the grayscale image at the last measurement time obtained based on the target tracking algorithm.

At S1305, whether the alternative region of the target object is the effective region of the target object is determined based on the verification algorithm. In some embodiments, the verification is successful, and the alternative region of the target object is determined to be the effective region of the target object.

At S1306, the position information of the target object is obtained based on the alternative region of the target object. In one example, the position information of the target object is the position information in the camera coordinate system.

At S1307, the position information of the target object is converted to the position information in the geodetic coordinate system.

At S1308, the position information of the target object is corrected to obtain the corrected position information of the target object.

At S1309, the UAV is controlled based on the corrected position information of the target object.

At S1310, the corrected position information is determined to be the reference position information for the subsequent measurement time of the target tracking algorithm.

When detecting the image obtained by the primary camera fails, the result of the target tracking algorithm is obtained. Because the accumulated errors occur in the target tracking algorithm, whether the result of the target tracking algorithm is accurate is determined based on the verification algorithm, thereby improving the accuracy of the target detection.

The present disclosure provides the target detection method. The method includes: detecting the image obtained by the primary camera based on the detection algorithm; and if the candidate region of the target object is obtained as a result of the detection, obtaining the alternative region of the target object in the grayscale image of the current time based on the target tracking algorithm. The candidate region of the target object becomes the reference region of the target object at the current time of the target tracking algorithm. The target detection method provided by the embodiments of the present disclosure combines the result of detecting the high resolution image obtained by the primary camera and the 2D image based target tracking algorithm, and corrects the target tracking algorithm, thereby improving the accuracy of the target detection.

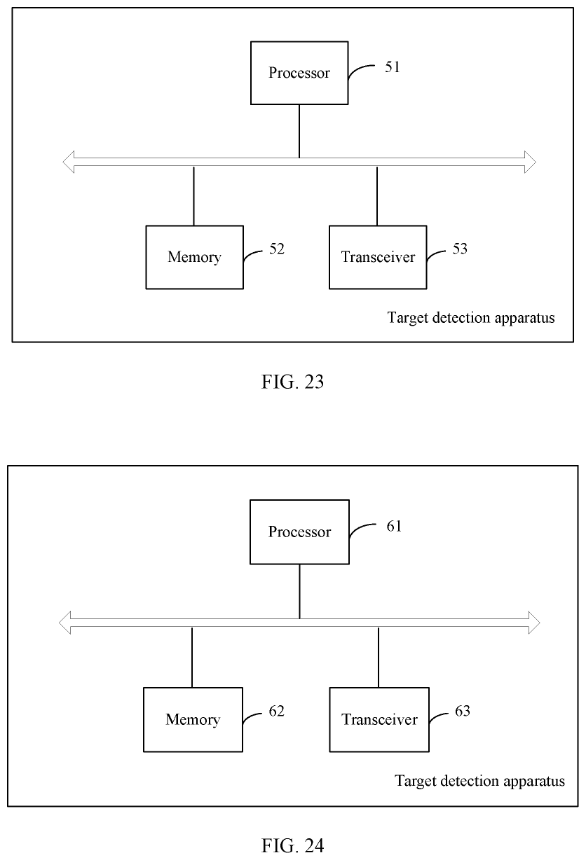

FIG. 23 is a schematic structural diagram of an example target detection apparatus consistent with the disclosure. The target detection apparatus can execute any of the target detection methods consistent with the disclosure, such as one of the example methods shown in FIGS. 2-13. As shown in FIG. 23, the target detection apparatus includes: a memory 52 and a processor 51. In some embodiments, the target detection apparatus further includes a transceiver 53.

The memory 52, the processor 51, and the transceiver 53 are connected by a bus.

The memory 52 includes a read-only memory (ROM) and a random-access memory (RAM), and provides instructions and data to the processor 51. Part of the memory 52 also includes a non-volatile RAM.

The transceiver 53 is configured to receive and transmit signals between the UAV and other devices. The received signal is processed by the processor 51. Information generated by the processor 51 may be transmitted to the other devices. The transceiver 53 may include separate transmitter and receiver.

The processor 51 may be a central processing unit (CPU). The processor 51 may be other general-purpose processors, digital signal processors (DSP), application specific integrated circuits (ASIC), field programmable gate arrays (FPGA), other programmable logic devices, discrete gates, transistor logic components, or discrete hardware components. The general-purpose processor may be a microprocessor or any conventional processor.

The memory 52 stores program codes.

The processor 51 invokes the program codes to perform: obtaining a depth image;

detecting the depth image based on a detection algorithm; if a candidate region of a target object is obtained as a result of the detection, determining whether the candidate region of the target object is an effective region of the target object based on a verification algorithm.

In some embodiments, if the candidate region of the target object is determined to be the effective region of the target object based on the verification algorithm, the processor 51 is further configured to: obtain position information of the target object based on the effective region of the target object; and control a UAV based on the position information of the target object.

In some embodiments, the processor 51 is further configured to: convert the position information of the target object to the position information in a geodetic coordinate system.

In some embodiments, the processor 51 is further configured to: obtain position-attitude information of the UAV; and convert the position information in a camera coordinate system to the position information in the geodetic coordinate system based on the position-attitude information of the UAV.

In some embodiments, if the candidate region of the target object is not obtained as the result of the detection, the processor 51 is further configured to: obtain an alternative region of the target object in a grayscale image of the current time based on a target tracking algorithm; and determine whether the alternative region of the target object is the effective region of the target object based on the verification algorithm.

In some embodiments, the processor 51 is further configured to: obtain the alternative region of the target object based on a reference region of the target object and the grayscale image of the current time. The reference region of the target object includes any one of the following: the effective region of the target object determined based on the verification algorithm, the candidate region of the target object determined by detecting the depth image based on the detection algorithm, and the alternative region of the target object determined based on the target tracking algorithm.

In some embodiments, the processor 51 is further configured to: if the alternative region of the target object is the effective region of the target object, obtain the position information of the target object based on the effective region of the target object.

In some embodiments, the processor 51 is further configured to: obtain the alternative region of the target object in the grayscale image of the current time based on the target tracking algorithm; and obtain the position information of the target object based on at least one of the candidate region of the target object or the alternative region of the target object.

In some embodiments, a first frequency is greater than a second frequency. The first frequency is the frequency of obtaining the alternative region of the target object in the grayscale image of the current time based on the target tracking algorithm. The second frequency is the frequency of detecting the depth image based on the detection algorithm.

In some embodiments, the processor 51 is further configured to: if the candidate region of the target object is the effective region of the target object, obtain the position information of the target object based on the effective region of the target object; or if the candidate region of the target object is the effective region of the target object, determine an average value or a weighted average value of first position information and second position information to be the position information of the target object, where the first position information is the position information of the target object determined based on the effective region of the target object, and the second position information is the position information of the target object determined based on the alternative region of the target object; or if the candidate region of the target object is not the effective region of the target object, obtain the position information of the target object based on the alternative region of the target object.

In some embodiments, the processor 51 is further configured to: determine whether the alternative region of the target object is valid based on the verification algorithm; and if the alternative region of the target object is valid, perform the process of obtaining the position information of the target object based on the candidate region of the target object and the alternative region of the target object.

In some embodiments, the processor 51 is further configured to: obtain the image of the current time by the primary camera; obtain an original grayscale image by a sensor matching the image obtained by the primary camera; detect the image obtained by the primary camera to obtain a reference candidate region of the target object; based on the reference candidate region and the original grayscale image, obtain a projection candidate region corresponding to the reference candidate region; and based on the projection candidate region, obtain the alternative region of the target object.

In some embodiments, the processor 51 is further configured to: determine the grayscale image having the smallest time stamp difference with the image to be the original grayscale image.

In some embodiments, the processor 51 is further configured to: obtain a time stamp of the image and a time stamp of at least one grayscale image within a certain time range of the time stamp of the image; calculate a difference between the time stamp of the image and the time stamp of the at least one grayscale image; and if the smallest of the at least one difference is smaller than a pre-set threshold, determine the grayscale image corresponding to the smallest difference to be the original grayscale image.

In some embodiments, the time stamp of the image is a mid-photographing time between the start of exposure and the end of exposure.

In some embodiments, the processor 51 is further configured to: if an image aspect ratio of the image is different from the image aspect ratio of the original grayscale image, crop the original grayscale image based on the image aspect ratio of the image.

In some embodiments, the processor 51 is further configured to: determine a scaling factor based on a focal length of the image and a focal length of the original grayscale image; and scale the original grayscale image based on the scaling factor.

In some embodiments, the processor 51 is further configured to: based on rotation relationship between the primary camera and the sensor, project the center point of the reference candidate region to the original grayscale image to obtain a projection center point; and based on the projection center point, obtain the projection candidate region in the original grayscale image based on a pre-set rule.

In some embodiments, the processor 51 is further configured to: based on the resolution of the image and the resolution of the original grayscale image, determine a change coefficient; based on the change coefficient and the size of the reference candidate region, obtain the size of a to-be-processed region in the original grayscale image corresponding to the reference candidate region; and determine a region formed by enlarging the to-be-processed region based on a pre-set factor to be the projection candidate region.

In some embodiments, if the candidate region of the target object is the effective region of the target object, the processor 51 is further configured to: obtain the alternative region of the target object in the grayscale image of the current time based on the target tracking algorithm; and obtain the position information of the target object based on the alternative region of the target object, where the effective region of the target object becomes the reference region of the target object at the current time of the target tracking algorithm.

In some embodiments, the processor 51 is further configured to: correct the position information of the target object to obtain a corrected position information of the target object.

In some embodiments, the processor 51 is further configured to: obtain estimated position information of the target object at the current time based on a pre-set movement model; and based on the estimated position information and the position information of the target object, obtain the corrected position information of the target object based on Kalman filter algorithm.

In some embodiments, the processor 51 is further configured to: convert the position information of the target object to the position information in the geodetic coordinate system.

In some embodiments, the processor 51 is further configured to: determine the corrected position information of the target object to be reference position information of the target object for a subsequent measurement time of the target tracking algorithm.

In some embodiments, the position information of the target object is the position information in the camera coordinate system.

In some embodiments, the processor 51 is further configured to: obtain the grayscale image by the sensor; and obtain the depth image based on the grayscale image.

In some embodiments, the processor 51 is further configured to: obtain the image by the primary camera and obtain the original grayscale image by the sensor matching the image obtained by the primary camera; detect the image based on the detection algorithm to obtain the reference candidate region of the target object; and based on the reference candidate region and the original grayscale image, obtain the depth image in the original grayscale image corresponding to the reference candidate region.

In some embodiments, the verification algorithm is a convolutional neural network (CNN) algorithm.

In some embodiments, the target object may be any one of the head, the upper arm, the torso, and the hand of a person.

The target detection apparatus provided by the present disclosure can execute any of the target detection methods in the embodiments shown in FIGS. 2-13. Because the operation principle and the technical effect are similar to the example embodiments described previously, the detailed description is omitted.

FIG. 24 is a schematic structural diagram of another example target detection apparatus consistent with the disclosure. The target detection apparatus can execute any of the target detection methods consistent with the disclosure, such as one of the example methods shown in FIGS. 14-18. As shown in FIG. 24, the target detection apparatus includes: a memory 62 and a processor 61. In some embodiments, the target detection apparatus further includes a transceiver 63.

The memory 62, the processor 61, and the transceiver 63 are connected by a bus.

The memory 62 includes a read-only memory (ROM) and a random-access memory (RAM), and provides instructions and data to the processor 61. Part of the memory 62 also includes a non-volatile RAM.

The transceiver 63 is configured to receive and transmit signals between the UAV and other devices. The received signal is processed by the processor 61. Information generated by the processor 61 may be transmitted to the other devices. The transceiver 63 may include separate transmitter and receiver.

The processor 61 may be a central processing unit (CPU). The processor 61 may be other general-purpose processors, digital signal processors (DSP), application specific integrated circuits (ASIC), field programmable gate arrays (FPGA), other programmable logic devices, discrete gates, transistor logic components, or discrete hardware components. The general-purpose processor may be a microprocessor or any conventional processor.

The memory 62 stores program codes.

The processor 61 invokes the program codes to perform: obtaining a depth image; detecting the depth image based on a detection algorithm; if a candidate region of a target object is obtained as a result of the detection, obtaining an alternative region of the target object in a grayscale image of the current time based on a target tracking algorithm, where the candidate region of the target object becomes a reference region of the target object at the current time of the target tracking algorithm.

In some embodiments, the processor 61 is further configured to: obtain position information of the target object based on the alternative region of the target object; and control a UAV based on the position information of the target object.

In some embodiments, the processor 61 is further configured to: convert the position information of the target object to the position information in a geodetic coordinate system.

In some embodiments, the processor 61 is further configured to: obtain position-attitude information of the UAV; and convert the position information in a camera coordinate system to the position information in the geodetic coordinate system based on the position-attitude information of the UAV.

In some embodiments, the processor 61 is further configured to: determine whether the candidate region of the target object is an effective region of the target object based on a verification algorithm; and if the candidate region of the target object is the effective region of the target object, perform the process of obtaining the alternative region of the target object in the grayscale image of the current time based on the target tracking algorithm.

In some embodiments, if the candidate region of the target object is not obtained as a result of the detection, the processor 61 is further configured to: obtain the alternative region of the target object in the grayscale image of the current time based on the target tracking algorithm; and determine whether the alternative region of the target object is the effective region of the target object based on the verification algorithm.

In some embodiments, the processor 61 is further configured to: obtain the alternative region of the target object based on a reference region of the target object and the grayscale image of the current time. The reference region of the target object includes any one of the following: the effective region of the target object determined based on the verification algorithm, the candidate region of the target object determined by detecting the depth image based on the detection algorithm, and the alternative region of the target object determined based on the target tracking algorithm.

In some embodiments, the processor 61 is further configured to: if the alternative region of the target object is the effective region of the target object, obtain the position information of the target object based on the effective region of the target object.

In some embodiments, a first frequency is greater than a second frequency. The first frequency is the frequency of obtaining the alternative region of the target object in the grayscale image of the current time based on the target tracking algorithm. The second frequency is the frequency of detecting the depth image based on the detection algorithm.

In some embodiments, the processor 61 is further configured to: obtain the image of the current time by a primary camera; obtain an original grayscale image by a sensor matching the image obtained by the primary camera; detect the image obtained by the primary camera to obtain a reference candidate region of the target object; based on the reference candidate region and the original grayscale image, obtain a projection candidate region corresponding to the reference candidate region; and based on the projection candidate region, obtain the alternative region of the target object.

In some embodiments, the processor 61 is further configured to: determine the grayscale image having the smallest time stamp difference with the image to be the original grayscale image.

In some embodiments, the processor 61 is further configured to: obtain a time stamp of the image and a time stamp of at least one grayscale image within a certain time range of the time stamp of the image; calculate a difference between the time stamp of the image and the time stamp of the at least one grayscale image; and if the smallest of the at least one difference is smaller than a pre-set threshold, determine the grayscale image corresponding to the smallest difference to be the original grayscale image.

In some embodiments, the time stamp of the image is a mid-photographing time between the start of exposure and the end of exposure.

In some embodiments, the processor 61 is further configured to: if an image aspect ratio of the image is different from the image aspect ratio of the original grayscale image, crop the original grayscale image based on the image aspect ratio of the image.

In some embodiments, the processor 61 is further configured to: determine a scaling factor based on a focal length of the image and a focal length of the original grayscale image; and scale the original grayscale image based on the scaling factor.

In some embodiments, the processor 61 is further configured to: based on rotation relationship between the primary camera and the sensor, project the center point of the reference candidate region to the original grayscale image to obtain a projection center point; and based on the projection center point, obtain the projection candidate region in the original grayscale image based on a pre-set rule.

In some embodiments, the processor 61 is further configured to: based on the resolution of the image and the resolution of the original grayscale image, determine a change coefficient; based on the change coefficient and the size of the reference candidate region, obtain the size of a to-be-processed region in the original grayscale image corresponding to the reference candidate region; and determine a region formed by enlarging the to-be-processed region based on a pre-set factor to be the projection candidate region.

In some embodiments, the processor 61 is further configured to: correct the position information of the target object to obtain a corrected position information of the target object.

In some embodiments, the processor 61 is further configured to: obtain estimated position information of the target object at the current time based on a pre-set movement model; and based on the estimated position information and the position information of the target object, obtain the corrected position information of the target object based on Kalman filter algorithm.

In some embodiments, the processor 61 is further configured to: convert the position information of the target object to the position information in the geodetic coordinate system.

In some embodiments, the processor 61 is further configured to: determine the corrected position information of the target object to be reference position information of the target object for a subsequent measurement time of the target tracking algorithm.

In some embodiments, the position information of the target object is the position information in the camera coordinate system.

In some embodiments, the processor 61 is further configured to: obtain the grayscale image by the sensor; and obtain the depth image based on the grayscale image.

In some embodiments, the processor 61 is further configured to: obtain the image by the primary camera and obtain the original grayscale image by the sensor matching the image obtained by the primary camera; detect the image based on the detection algorithm to obtain the reference candidate region of the target object; and based on the reference candidate region and the original grayscale image, obtain the depth image in the original grayscale image corresponding to the reference candidate region.

In some embodiments, the verification algorithm is a convolutional neural network (CNN) algorithm.

In some embodiments, the target object may be any one of the head, the upper arm, the torso, and the hand of a person.

The target detection apparatus provided by the present disclosure can execute any of the target detection methods in the embodiments shown in FIGS. 14-18. Because the operation principle and the technical effect are similar to the example embodiments described previously, the detailed description is omitted.

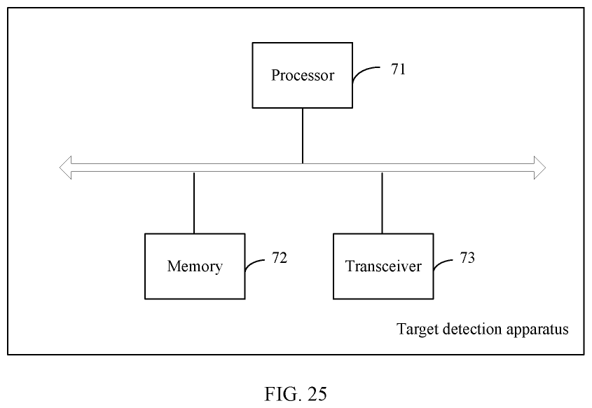

FIG. 25 is a schematic structural diagram of another example target detection apparatus consistent with the disclosure. The target detection apparatus can execute any of the target detection methods consistent with the disclosure, such as one of the example methods shown in FIGS. 19-22. As shown in FIG. 25, the target detection apparatus includes: a memory 72 and a processor 71. In some embodiments, the target detection apparatus further includes a transceiver 73.

The memory 72, the processor 71, and the transceiver 73 are connected by a bus.

The memory 72 includes a read-only memory (ROM) and a random-access memory (RAM), and provides instructions and data to the processor 71. Part of the memory 72 also includes a non-volatile RAM.

The transceiver 73 is configured to receive and transmit signals between the UAV and other devices. The received signal is processed by the processor 71. Information generated by the processor 71 may be transmitted to the other devices. The transceiver 73 may include separate transmitter and receiver.

The processor 71 may be a central processing unit (CPU). The processor 71 may be other general-purpose processors, digital signal processors (DSP), application specific integrated circuits (ASIC), field programmable gate arrays (FPGA), other programmable logic devices, discrete gates, transistor logic components, or discrete hardware components. The general-purpose processor may be a microprocessor or any conventional processor.

The memory 72 stores program codes.

The processor 71 invokes the program codes to perform: obtaining a image by a primary camera; detecting the depth image based on a detection algorithm; if a candidate region of a target object is obtained as a result of the detection, obtaining an alternative region of the target object in a grayscale image of the current time based on a target tracking algorithm, where the candidate region of the target object becomes a reference region of the target object at the current time of the target tracking algorithm.

In some embodiments, the processor 71 is further configured to: obtain position information of the target object based on the alternative region of the target object; and control a UAV based on the position information of the target object.

In some embodiments, the processor 71 is further configured to: convert the position information of the target object to the position information in a geodetic coordinate system.

In some embodiments, the processor 71 is further configured to: obtain position-attitude information of the UAV; and convert the position information in a camera coordinate system to the position information in the geodetic coordinate system based on the position-attitude information of the UAV.

In some embodiments, the processor 71 is further configured to: determine whether the candidate region of the target object is an effective region of the target object based on a verification algorithm; and if the candidate region of the target object is the effective region of the target object, perform the process of obtaining the alternative region of the target object in the grayscale image of the current time based on the target tracking algorithm.

In some embodiments, if the candidate region of the target object is not obtained as a result of the detection, the processor 71 is further configured to: obtain the alternative region of the target object in the grayscale image of the current time based on the target tracking algorithm; and determine whether the alternative region of the target object is the effective region of the target object based on the verification algorithm.

In some embodiments, the processor 71 is further configured to: obtain the alternative region of the target object based on a reference region of the target object and the grayscale image of the current time. The reference region of the target object includes any one of the following: the effective region of the target object determined based on the verification algorithm, and the alternative region of the target object determined based on the target tracking algorithm.

In some embodiments, the processor 71 is further configured to: if the alternative region of the target object is the effective region of the target object, obtain the position information of the target object based on the effective region of the target object.

In some embodiments, the processor 71 is further configured to: obtain the image of the current time by a primary camera; obtain an original grayscale image by a sensor matching the image obtained by the primary camera; detect the image obtained by the primary camera to obtain a reference candidate region of the target object; based on the reference candidate region and the original grayscale image, obtain a projection candidate region corresponding to the reference candidate region; and detect the projection candidate region of the target object.

In some embodiments, the processor 71 is further configured to: determine the grayscale image having the smallest time stamp difference with the image to be the original grayscale image.

In some embodiments, the processor 71 is further configured to: obtain a time stamp of the image and a time stamp of at least one grayscale image within a certain time range of the time stamp of the image; calculate a difference between the time stamp of the image and the time stamp of the at least one grayscale image; and if the smallest of the at least one difference is smaller than a pre-set threshold, determine the grayscale image corresponding to the smallest difference to be the original grayscale image.

In some embodiments, the time stamp of the image is a mid-photographing time between the start of exposure and the end of exposure.

In some embodiments, the processor 71 is further configured to: if an image aspect ratio of the image is different from the image aspect ratio of the original grayscale image, crop the original grayscale image based on the image aspect ratio of the image.

In some embodiments, the processor 71 is further configured to: determine a scaling factor based on a focal length of the image and a focal length of the original grayscale image; and scale the original grayscale image based on the scaling factor.

In some embodiments, the processor 71 is further configured to: based on rotation relationship between the primary camera and the sensor, project the center point of the reference candidate region to the original grayscale image to obtain a projection center point; and based on the projection center point, obtain the projection candidate region in the original grayscale image based on a pre-set rule.

In some embodiments, the processor 71 is further configured to: based on the resolution of the image and the resolution of the original grayscale image, determine a change coefficient; based on the change coefficient and the size of the reference candidate region, obtain the size of a to-be-processed region in the original grayscale image corresponding to the reference candidate region; and determine a region formed by enlarging the to-be-processed region based on a pre-set factor to be the projection candidate region.

In some embodiments, the processor 71 is further configured to: correct the position information of the target object to obtain a corrected position information of the target object.

In some embodiments, the processor 71 is further configured to: obtain estimated position information of the target object at the current time based on a pre-set movement model; and based on the estimated position information and the position information of the target object, obtain the corrected position information of the target object based on Kalman filter algorithm.

In some embodiments, the processor 71 is further configured to: convert the position information of the target object to the position information in the geodetic coordinate system.

In some embodiments, the processor 71 is further configured to: determine the corrected position information of the target object to be reference position information of the target object for a subsequent measurement time of the target tracking algorithm.

In some embodiments, the position information of the target object is the position information in the camera coordinate system.

In some embodiments, the verification algorithm is a convolutional neural network (CNN) algorithm.

In some embodiments, the target object may be any one of the head, the upper arm, the torso, and the hand of a person.

The target detection apparatus provided by the present disclosure can execute any of the target detection methods in the embodiments shown in FIGS. 19-22. Because the operation principle and the technical effect are similar to the example embodiments described previously, the detailed description is omitted.

The present disclosure also provides a movable platform. The movable platform includes any one of the target detection apparatus in the embodiments shown in FIGS. 23-25.

The present disclosure does not limit the type of the movable platform. For example, the movable platform may be a UAV, or an unmanned automobile.

In this case, the present disclosure does not limit other devices also included in the movable platform.

Those skilled in the art may understand that all or part of the processes of the foregoing method embodiments may be completed by a program instructing relevant hardware. The program may be stored in a computer-readable storage medium. When the program is executed, the processes of the foregoing method embodiments are performed. The computer-readable storage medium includes any medium that can store program codes, such as a ROM, a RAM, a magnetic disk, or an optical disk.

The terms “first,” “second,” “third,” and “fourth,” etc. (if applicable) in the description and claims of the specification and the drawings are intended to distinguish similar objects without specifying a particular order or sequence. It should be understood that the data used in this way can be interchanged under appropriate circumstances, so that the embodiments of the present disclosure described herein can be implemented in an order other than those illustrated or described herein. In addition, the terms “including” and “having” and variations thereof are intended to cover non-exclusive inclusions, for example, processes, methods, systems, products, or devices that contain a series of steps or units, and need not be limited to the explicitly listed steps or units, but may include other steps or units that are not explicitly listed or other steps or units inherent to these processes, methods, products, or devices. In addition, in the case of no conflict, the technical features in the embodiments of the present disclosure can be arbitrarily combined.

Various embodiments of the present disclosure are used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. The scope of invention should be determined by the appended claims.

What is claimed is:

1. A target detection method comprising:
obtaining a depth image;
performing detection on the depth image based on a detection algorithm; and
in response to obtaining a candidate region of a target object as a result of the detection, determining whether the candidate region of the target object is an effective region of the target object based on a verification algorithm.

2. The method of claim 1, further comprising, in response to determining that the candidate region of the target object is the effective region of the target object:
obtaining position information of the target object based on the effective region of the target object; and
controlling a movable platform based on the position information of the target object.

3. The method of claim 2, further comprising, before controlling the movable platform based on the position information of the target object:
converting the position information of the target object to position information in a geodetic coordinate system.

4. The method of claim 3, wherein converting the position information of the target object to the position information in the geodetic coordinate system includes:
obtaining position-attitude information of the movable platform; and
converting the position information of the target object to the position information in the geodetic coordinate system based on the position-attitude information of the movable platform.

5. The method of claim 1, further comprising, in response to the candidate region of the target object not being obtained from the detection:
obtaining an alternative region of the target object in a current grayscale image of a current time based on a target tracking algorithm; and
determining whether the alternative region of the target object is the effective region of the target object based on the verification algorithm.

6. The method of claim 5, wherein obtaining the alternative region of the target object in the current grayscale image includes:
obtaining the alternative region of the target object based on a reference region of the target object and the current grayscale image, the reference region of the target object including one of the effective region of the target object determined based the detection algorithm, the candidate region of the target object determined by detecting the depth image based on the detection algorithm, and the alternative region of the target object determined based on the target tracking algorithm.

7. The method of claim 5, further comprising:
in response to determining that the alternative region of the target object is the effective region of the target object, obtaining position information of the target object based on the effective region of the target object.

8. The method of claim 1, further comprising:
obtaining an alternative region of the target object in a current grayscale image of a current time based on a target tracking algorithm; and
obtaining position information of the target object based on at least one of the candidate region of the target object or the alternative region of the target object.

9. The method of claim 8, wherein a first frequency for obtaining the alternative region of the target object in the current grayscale image is higher than a second frequency for performing the detection on the depth image.

10. The method of claim 8, wherein obtaining the position information of the target object based on the at least one of the candidate region of the target object or the alternative region of the target object includes:
in response to the candidate region of the target object being the effective region of the target object:
obtaining the position information of the target object based on the effective region of the target object; or
determining an average value or a weighted average value of:
first position information of the target object determined based on the effective region of the target object, and
second position information of the target object determined based on the alternative region of the target object; or
in response to the candidate region of the target object being not the effective region of the target object, obtaining the position information of the target object based on the alternative region of the target object.

11. The method of claim 8, further comprising, before obtaining the position information of the target object based on the at least one of the candidate region of the target object or the alternative region of the target object:
determining whether the alternative region of the target object is valid based on the verification algorithm; and
wherein obtaining the position information of the target object based on the at least one of the candidate region of the target object or the alternative region of the target object includes, in response to determining that the alternative region of the target object is valid, obtaining the position information of the target object based on the candidate region of the target object and the alternative region of the target object.

12. The method of claim 8, wherein obtaining the alternative region of the target object in the current grayscale image based on the target tracking algorithm includes:
obtaining, through a primary camera, a primary image of the current time;
obtaining, through a sensor, an original grayscale image matching the primary image;
performing detection on the primary image to obtain a reference candidate region of the target object;
obtaining a projection candidate region corresponding to the reference candidate region based on the reference candidate region and the original grayscale image; and
obtaining the alternative region of the target object based on the projection candidate region.

13. The method of claim 12, wherein obtaining the original grayscale image matching the primary image includes:
determining, from one or more grayscale images, a closest grayscale image having a smallest time stamp difference with the primary image to be the original grayscale image.

14. The method of claim 13, wherein determining the closest grayscale image to be the original grayscale image includes:
obtaining a time stamp of the primary image and a time stamp of each of the one or more grayscale images, the time stamp of each of the one or more grayscale images being within a time range including the time stamp of the primary image;
calculating a difference between the time stamp of the primary image and the time stamp of each of the one or more grayscale images to obtain one or more time differences; and
in response to a smallest time difference of the one or more time differences being smaller than a pre-set threshold, determining the grayscale image corresponding to the smallest time difference to be the original grayscale image.

15. The method of claim 13, wherein:
a time stamp of the primary image or one of the one or more grayscale images is a mid time between a start time of exposure for the primary image or the one of the one or more grayscale images and an end time of the exposure.

16. The method of claim 12, further comprising, after obtaining the original grayscale image:
in response to an image aspect ratio of the primary image being different from an image aspect ratio of the original grayscale image, cropping the original grayscale image based on the image aspect ratio of the primary image.

17. The method of claim 12, further comprising, after obtaining the original grayscale image:
determining a scaling factor based on a focal length of the primary camera and a focal length of the sensor; and
scaling the original grayscale image based on the scaling factor.

18. The method of claim 12, wherein obtaining the projection candidate region corresponding to the reference candidate region based on the reference candidate region and the original grayscale image includes:
projecting a center point of the reference candidate region to the original grayscale image to obtain a projection center point based on a rotation relationship between the primary camera and the sensor; and
obtaining the projection candidate region in the original grayscale image based on a pre-set rule and using the projection center point as a center.

19. A target detection method comprising:
obtaining a depth image;
performing detection on the depth image based on a detection algorithm; and
in response to obtaining a candidate region of a target object as a result of the detection, obtaining an alternative region of the target object in a current grayscale image of a current time based on a target tracking algorithm using the candidate region of the target object as a reference region of the target object at the current time in the target tracking algorithm.

20. A target detection method comprising:
performing detection on a primary image obtained by a primary camera; and
in response to obtaining a candidate region of a target object as a result of the detection, obtaining an alternative region of the target object in a current grayscale image of a current time based on a target tracking algorithm using the candidate region of the target object as a reference region of the target object at the current time in the target tracking algorithm.
